(19) United States
(12) Patent Application Publication
(10) Pub. No.: US 2026/0213196 A1
(43) Pub. Date: Jul. 23, 2026

(54) PRELITHIATED NEGATIVE ELECTRODE PLATE, PREPARATION METHOD OF LITHIUM SUPPLEMENTATION COMPOSITE LAYER, LITHIUM SUPPLEMENTATION METHOD, SECONDARY BATTERY, AND ELECTRONIC APPARATUS

(71) Applicant: Ningde Amperex Technology Limited, Ningde City (CN)

(72) Inventor: Mingju Liu, Ningde City (CN)

(73) Assignee: Ningde Amperex Technology Limited, Ningde City (CN)

(21) Appl. No.: 19/457,436

(22) Filed: Jan. 23, 2026

(30) Foreign Application Priority Data
Jan. 23, 2025 (CN) 202510111680.2

(51) Int. Cl. H01M 4/583; H01M 4/02; H01M 4/04; H01M 4/1393; H01M 4/38; H01M 4/62

(52) U.S. Cl. CPC H01M 4/583; H01M 4/0435; H01M 4/1393; H01M 4/386; H01M 4/625; H01M 4/626; H01M 2004/021; H01M 2004/027

(57) ABSTRACT

A negative electrode material layer includes a first surface and a second surface opposite each other. From the first surface to the second surface, the negative electrode material layer sequentially includes a first region, a second region, and a third region, the third region being located on a surface of the negative electrode current collector. A thickness of the first region, the second region, and the third region each account for ⅓ of a thickness of the negative electrode material layer Based on a mass of the first region, a mass percentage of lithium element is W1, based on a mass of the second region, a mass percentage of lithium element is W2, and based on a mass of the third region, a mass percentage of lithium element is W3, where W1>W2>W3, 1.01≤W1/W2≤2.0, and 1.01≤W2/W3≤2.0.

### CROSS-REFERENCE TO RELATED APPLICATIONS

This application claims priority to Chinese Patent Application No. 202510111680.2, filed on Jan. 23, 2025, the whole disclosure of which is incorporated herein by reference.

### TECHNICAL FIELD

This application relates to the field of electrochemical technology, and in particular, to a prelithiated negative electrode plate, a preparation method of lithium supplementation composite layer, a lithium supplementation method, a secondary battery, and an electronic apparatus.

### BACKGROUND

With advantages such as high energy density, high power, and long cycle life, lithium-ion batteries are widely used in consumer electronics, electric bicycles, and electric vehicles. As their application scope continues to expand, the requirements for energy density and cycling performance of lithium-ion batteries are constantly increasing. The currently commonly used graphite material for lithium-ion battery negative electrodes can no longer meet the energy density requirements. Although silicon-carbon and silicon-oxygen negative electrode materials have high theoretical specific capacities and are ideal materials to replace graphite negative electrode materials and enhance the energy density of lithium-ion batteries, their widespread use has been hindered by issues such as low initial Coulombic efficiency and poor cycle life. Existing methods to improve the initial Coulombic efficiency and reduce cycling degradation of silicon-carbon or silicon-oxygen negative electrodes involve prelithiating the negative electrode plate to compensate for the irreversible capacity consumed during the initial charge, discharge, and cycling, thereby improving the initial Coulombic efficiency of lithium-ion batteries with silicon-carbon or silicon-oxygen negative electrodes and further enhancing the energy density of lithium-ion batteries.

Existing lithium supplementation methods for negative electrode plates mainly include lithium powder supplementation, lithium tape supplementation, and electrochemical lithium supplementation. However, these three methods have some issues in terms of environmental control, uniformity of lithium supplementation, and side reactions after lithium supplementation. Therefore, there is an urgent need to provide a prelithiated negative electrode plate that can improve the initial Coulombic efficiency of lithium-ion batteries containing silicon-carbon or silicon-oxygen negative electrodes, reduce cycling capacity degradation, and enhance the energy density of lithium-ion batteries.

### SUMMARY

The purpose of this application is to provide a prelithiated negative electrode plate, a preparation method of lithium supplementation composite layer, a lithium supplementation method, a secondary battery, and an electronic apparatus, so as to improve initial Coulombic efficiency of the secondary battery, reduce cycling capacity degradation, and enhance energy density of the secondary battery. The specific technical solutions are as follows.

A first aspect of this application provides a preparation method of lithium supplementation composite layer, including the following steps:
(1) applying a lithium metal powder slurry onto a support layer, followed by drying and rolling, to form a lithium supplementation layer; or rolling lithium foil and/or lithium alloy foil onto a support layer to form a lithium supplementation layer; or applying a molten lithium or lithium alloy slurry onto a support layer, followed by cooling and rolling, to form a lithium supplementation layer; where a rolling pressure P1 is 0.1 T/10 mm to 2 T/10 mm; and
(2) applying interface particles onto a surface of the lithium supplementation layer to form an interface layer, followed by rolling, to form a lithium supplementation composite layer, where a rolling pressure P2 is 0.1 T/10 mm to 2 T/10 mm, a rolling temperature T1 is 25° C. to 170° C., and a rolling rest time t1 is 5 min to 50 min.

In an embodiment of this application, the lithium supplementation composite layer includes the support layer, the lithium supplementation layer, and the interface layer, where the lithium supplementation layer is disposed between the support layer and the interface layer, the interface layer includes the interface particles, and the lithium supplementation layer includes at least one of lithium foil or lithium alloy foil.

The foregoing method is used to prepare the lithium supplementation composite layer, followed by prelithiation treatment of the negative electrode plate, facilitating lithium supplementation of the negative electrode plate. The resulting prelithiated negative electrode plate, when applied to a secondary battery, can improve the initial Coulombic efficiency of the secondary battery, reduce cycling capacity degradation, and enhance the energy density of the secondary battery.

In an embodiment of this application, the interface particles include at least one of a conductive agent or a lithiation material; the conductive agent includes at least one of conductive carbon black, carbon fiber, graphene, or carbon nanotubes; and the lithiation material includes at least one of artificial graphite, natural graphite, hard carbon, silicon-carbon material, or silicon-oxygen material. The use of the foregoing interface particles allows the interface layer to have good electron and ion conductivity, which facilitates the rapid transfer of electrons and lithium ions through the interface layer to the surface or interior of the negative electrode material layer during prelithiation, facilitating further lithium supplementation to the negative electrode plate. This can further improve the initial Coulombic efficiency of the secondary battery, further reduce cycling capacity degradation, and further enhance the energy density of the secondary battery.

In an embodiment of this application, a thickness H1 of the interface layer is 0.1 μm to 50 μm, and preferably, the thickness H1 of the interface layer is 1 μm to 20 μm. Lithium atoms lose electrons in the lithium supplementation layer to form lithium ions, and the electrons and lithium ions are transferred through the interface layer to the surface or interior of the negative electrode material layer. By controlling the thickness of the interface layer within the range of this application, the interface layer has an appropriate thickness, the transmission distance of electrons and lithium ions is moderate, and electrons and lithium ions can effectively recombine to form lithiated compounds, facilitating further lithium supplementation of the negative electrode plate. This further improves the initial Coulombic efficiency of the secondary battery, further reduces cycling capacity degradation, and further enhances the energy density of the secondary battery.

In an embodiment of this application, a coverage ratio s1 of the interface particles on the lithium supplementation layer is 50% to 100%, and preferably, the coverage ratio s1 of the interface particles on the lithium supplementation layer is 80% to 100%. When the coverage ratio of the interface particles on the lithium supplementation layer is within the range of this application, the coverage ratio of the interface particles on the lithium supplementation layer is relatively high, resulting in a high uniformity of lithium supplementation in the negative electrode material layer. This can further improve the initial Coulombic efficiency of the secondary battery, further reduce cycling capacity degradation, and further enhance the energy density of the secondary battery.

In an embodiment of this application, the interface particles are embedded in the lithium supplementation layer, and a depth of the interface particles embedded in the lithium supplementation layer accounts for 10% to 95% of the thickness of the interface layer, and preferably, the depth of the interface particles embedded in the lithium supplementation layer accounts for 20% to 70% of the thickness of the interface layer. When the interface particles are embedded in the lithium supplementation layer and the proportion of the depth of the interface particles embedded in the lithium supplementation layer to the thickness of the interface layer is within the range of this application, lithium inside the lithium supplementation layer can be better promoted to participate in the oxidation reaction, thereby better transferring the lithium inside the lithium supplementation layer to the negative electrode material layer, and facilitating further lithium supplementation of the negative electrode plate. This can further improve the initial Coulombic efficiency of the secondary battery, further reduce cycling capacity degradation, and further enhance the energy density of the secondary battery. This also facilitates the repeated use of the lithium supplementation composite layer.

In an embodiment of this application, the support layer includes at least one of metal foil, polyethylene terephthalate film, polypropylene film, or polyethylene film, and the metal foil includes copper foil, nickel foil, steel foil, or copper-nickel alloy foil. By using such support layer, the support layer can provide good support for the lithium supplementation layer and the interface layer, improving the mechanical strength of the lithium supplementation composite layer. This enables the lithium supplementation composite layer to be smoothly peeled off from the surface of the negative electrode material layer after lithium supplementation, reducing the likelihood of fracture in the lithium supplementation composite layer, and facilitating lithium supplementation of the negative electrode plate. This can further improve the initial Coulombic efficiency of the secondary battery, further reduce cycling capacity degradation, and further enhance the energy density of the secondary battery.

A second aspect of this application provides a lithium supplementation method, including the following steps:
drying a negative electrode plate, where the negative electrode plate includes a negative electrode current collector and a negative electrode material layer disposed on at least one surface of the negative electrode current collector; and
laminating the lithium supplementation composite layer according to any one of the foregoing embodiments with the negative electrode plate to bring the interface layer into contact with the negative electrode material layer, performing prelithiation treatment, where an interface pressure P3 between the interface layer and the negative electrode material layer is 0.1 MPa to 2 MPa, a lamination time t2 between the interface layer and the negative electrode material layer is 0.5 h to 72 h, and a lamination temperature T2 between the interface layer and the negative electrode material layer is 50° C. to 180° C., and after the prelithiation treatment ends, peeling off the lithium supplementation composite layer from the negative electrode plate to form a prelithiated negative electrode plate.

The preparation method of lithium supplementation composite layer provided in this application is used to prepare the lithium supplementation composite layer, and then the lithium supplementation method provided in this application is used to prepare the prelithiated negative electrode plate, facilitating lithium supplementation of the negative electrode plate. The resulting prelithiated negative electrode plate, when applied to a secondary battery, can improve the initial Coulombic efficiency of the secondary battery, reduce cycling capacity degradation, and enhance the energy density of the secondary battery.

A third aspect of this application provides a prelithiated negative electrode plate prepared using the lithium supplementation method according to any one of the foregoing embodiments, where the negative electrode plate includes a negative electrode current collector and a negative electrode material layer. Along a thickness direction of the negative electrode plate, the negative electrode material layer includes a first surface and a second surface opposite each other. From the first surface to the second surface, the negative electrode material layer sequentially includes a first region, a second region, and a third region, the third region being located on a surface of the negative electrode current collector. A thickness of the first region accounts for ⅓ of a thickness of the negative electrode material layer, a thickness of the second region accounts for ⅓ of the thickness of the negative electrode material layer, and a thickness of the third region accounts for ⅓ of the thickness of the negative electrode material layer. Based on a mass of the first region, a mass percentage of lithium element is W1, based on a mass of the second region, a mass percentage of lithium element is W2, and based on a mass of the third region, a mass percentage of lithium element is W3, where W1>W2>W3, 1.01≤W1/W2≤2.0, and 1.01≤W2/W3≤2.0. The foregoing prelithiated negative electrode plate, when applied to a secondary battery, can improve the initial Coulombic efficiency of the secondary battery, reduce cycling capacity degradation, and enhance the energy density of the secondary battery.

In an embodiment of this application, the negative electrode material layer includes a negative electrode active material, where the negative electrode active material includes at least one of a carbon material or a silicon-containing substance, the carbon material includes at least one of a graphite material or hard carbon, and the silicon-containing substance includes at least one of a silicon-carbon material or a silicon-oxygen material. When the negative electrode material layer includes the negative electrode active material, and the negative electrode active material includes the foregoing substance, the prelithiated negative electrode plate has a relatively high lithium supplementation amount, and the prepared secondary battery has a high initial Coulombic efficiency, low cycling capacity degradation, and high energy density.

In an embodiment of this application, the negative electrode active material includes only the silicon-containing substance, and based on a mass of the negative electrode material layer, a mass percentage of silicon element in the negative electrode material layer is w1, where 18.6%≤w1≤63.5%, 11.5%≤W1≤18.4%, 9.2%≤W2<11.5%, and 4.6%≤W3<9.2%. The negative electrode active material includes only the silicon-containing substance, and the silicon-containing substance has a relatively high specific capacity. When the mass percentage w1 of silicon element in the negative electrode material layer, W1, W2, and W3 are within the ranges of this application, the negative electrode material layer has a high capacity, high ionic conductivity, and high electronic conductivity, and the prelithiated negative electrode plate has a relatively high lithium supplementation amount. The foregoing prelithiated negative electrode plate, when applied to a secondary battery, can further improve the initial Coulombic efficiency of the secondary battery, further reduce cycling capacity degradation, and further enhance the energy density of the secondary battery.

In an embodiment of this application, the negative electrode active material includes the carbon material and the silicon-containing substance, and based on a mass of the negative electrode material layer, a mass percentage of silicon element in the negative electrode material layer is w1, where 1.1%≤w1≤3.4%, 0.38%≤W1≤0.60%, 0.30%≤W2<0.38%, and 0.15%≤W3<0.30%. The negative electrode active material includes the carbon material and the silicon-containing substance, and within the same prelithiation treatment time, different negative electrode active materials have different lithium supplementation efficiencies, with the silicon-containing substance having a lower lithium supplementation amount and the carbon material having a higher lithium supplementation amount, which affects the lithium supplementation amount in the prelithiated negative electrode plate. When the mass percentage w1 of silicon element in the negative electrode material layer, W1, W2, and W3 are within the ranges of this application, the carbon material and the silicon-containing substance have appropriate mass percentages, and the negative electrode active material has a high capacity and a high lithium supplementation amount, enabling the prelithiated negative electrode plate to have a high capacity and a high lithium supplementation amount. The foregoing prelithiated negative electrode plate, when applied to a secondary battery, can further improve the initial Coulombic efficiency of the secondary battery, further reduce cycling capacity degradation, and further enhance the energy density of the secondary battery.

In an embodiment of this application, the negative electrode active material includes the carbon material and the silicon-containing substance, and based on a mass of the negative electrode material layer, a mass percentage of silicon element in the negative electrode material layer is w1, where 3.3%≤w1≤10.2%, 2.8%≤W1≤4.5%, 2.2%≤W2<2.8%, and 1.1%≤W3<2.2%. The negative electrode active material includes the carbon material and the silicon-containing substance, and within the same prelithiation treatment time, different negative electrode active materials have different lithium supplementation efficiencies, with the silicon-containing substance having a lower lithium supplementation amount and the carbon material having a higher lithium supplementation amount, which affects the lithium supplementation amount in the prelithiated negative electrode plate. When the mass percentage w1 of silicon element in the negative electrode material layer, W1, W2, and W3 are within the ranges of this application, the carbon material and the silicon-containing substance have appropriate mass percentages, and the negative electrode active material has a high capacity and a high lithium supplementation amount, enabling the prelithiated negative electrode plate to have a high capacity and a high lithium supplementation amount. The foregoing prelithiated negative electrode plate, when applied to a secondary battery, can further improve the initial Coulombic efficiency of the secondary battery, further reduce cycling capacity degradation, and further enhance the energy density of the secondary battery.

In an embodiment of this application, a porosity of the first region is S1, a porosity of the second region is S2, and a porosity of the third region is S3, where S1>S2>S3. When S1, S2, and S3 satisfy the above relationship, the migration of lithium ions along the thickness direction of the negative electrode plate is facilitated, improving the kinetic performance of the negative electrode plate.

In an embodiment of this application, 1.01≤S1/S2≤1.5, and 1.01≤S2/S3≤1.5. When the values of S1/S2 and S2/S3 are within the ranges of this application, the porosity of the first region>the porosity of the second region>the porosity of the third region, which facilitates the migration of lithium ions along the thickness direction of the negative electrode plate, further improving the kinetic performance of the negative electrode plate.

In an embodiment of this application, the negative electrode active material includes only the silicon-containing substance, and based on a mass of the negative electrode material layer, a mass percentage of silicon element in the negative electrode material layer is w1, where 18.6%≤w1≤63.5%, 42.1%≤S1≤57.0%, 38.0%≤S2<42.1%, and 25.0%≤S3<38.0%. The negative electrode active material includes only the silicon-containing substance, and the silicon-containing substance has a relatively high specific capacity. When the mass percentage w1 of silicon element in the negative electrode material layer, S1, S2, and S3 are within the ranges of this application, the migration of lithium ions along the thickness direction of the negative electrode plate is facilitated, further improving the kinetic performance of the negative electrode plate while ensuring that the negative electrode plate has a high capacity.

In an embodiment of this application, the negative electrode active material includes the carbon material and the silicon-containing substance, and based on a mass of the negative electrode material layer, a mass percentage of silicon element in the negative electrode material layer is w1, where 1.1%≤w1≤3.4%, 26.3%≤S1≤35.5%, 23.7%≤S2<26.3%, and 15.8%≤S3<23.7%. The negative electrode active material includes the carbon material and the silicon-containing substance, which facilitates further improvement of the specific capacity and lithium supplementation amount of the negative electrode active material. When the mass percentage w1 of silicon element in the negative electrode material layer, S1, S2, and S3 are within the ranges of this application, the migration of lithium ions along the thickness direction of the negative electrode plate is facilitated, further improving the kinetic performance of the negative electrode plate while ensuring that the negative electrode plate has a high capacity.

In an embodiment of this application, the negative electrode active material includes the carbon material and the silicon-containing substance, and based on a mass of the negative electrode material layer, a mass percentage of silicon element in the negative electrode material layer is w1, where 3.3%≤w1≤10.2%, 31.6%≤S1≤42.6%, 28.4%≤S2<31.6%, and 18.9%≤S3<28.4%. The negative electrode active material includes the carbon material and the silicon-containing substance, which facilitates further improvement of the specific capacity and lithium supplementation amount of the negative electrode active material. When the mass percentage w1 of silicon element in the negative electrode material layer, S1, S2, and S3 are within the ranges of this application, the migration of lithium ions along the thickness direction of the negative electrode plate is facilitated, further improving the kinetic performance of the negative electrode plate while ensuring that the negative electrode plate has a high capacity.

A fourth aspect of this application provides a secondary battery including the prelithiated negative electrode plate according to any one of the foregoing embodiments. Therefore, the secondary battery provided in this application has a high initial Coulombic efficiency, low cycling capacity degradation, and high energy density.

A fifth aspect of this application provides an electronic apparatus including the secondary battery according to any one of the foregoing embodiments. Therefore, the electronic apparatus provided in this application has a high initial Coulombic efficiency, low cycling capacity degradation, and high energy density.

### Beneficial Effects of this Application

This application provides a prelithiated negative electrode plate, a preparation method of lithium supplementation composite layer, a lithium supplementation method, a secondary battery, and an electronic apparatus. The prelithiated negative electrode plate includes a negative electrode current collector and a negative electrode material layer, where along a thickness direction of the negative electrode plate, the negative electrode material layer includes a first surface and a second surface opposite each other. From the first surface to the second surface, the negative electrode material layer sequentially includes a first region, a second region, and a third region, the third region being located on a surface of the negative electrode current collector. A thickness of the first region accounts for ⅓ of a thickness of the negative electrode material layer, a thickness of the second region accounts for ⅓ of the thickness of the negative electrode material layer, and a thickness of the third region accounts for ⅓ of the thickness of the negative electrode material layer. Based on a mass of the first region, a mass percentage of lithium element is W1, based on a mass of the second region, a mass percentage of lithium element is W2, and based on a mass of the third region, a mass percentage of lithium element is W3, where W1>W2>W3, 1.01≤W1/W2≤2.0, and 1.01≤W2/W3≤2.0. The prelithiated negative electrode plate satisfying the foregoing characteristics can improve initial Coulombic efficiency of the secondary battery, reduce cycling capacity degradation, and enhance energy density of the secondary battery.

Certainly, implementing any product or method of this application does not necessarily require all the advantages described above.

### DESCRIPTION OF THE DRAWINGS

To describe the technical solutions in the embodiments of this application or in the prior art more clearly, the following briefly describes the accompanying drawings for describing the embodiments or the prior art. Apparently, the accompanying drawings in the following description show merely some embodiments of this application, and persons of ordinary skill in the art may still derive other embodiments from these accompanying drawings without creative efforts.

FIG. 1 is a schematic structural diagram of a lithium supplementation composite layer according to an embodiment of this application;

FIG. 2 is a schematic structural diagram of a negative electrode plate and a lithium supplementation composite layer during prelithiation according to an embodiment of this application;

FIG. 3 is a schematic structural diagram of a prelithiated negative electrode plate according to an embodiment of this application;

FIG. 4 is a schematic diagram of a lithium supplementation region and an interface region;

FIG. 5 is a schematic diagram of a total area of a lithium supplementation region and a total area of an interface region;

FIG. 6 is a schematic diagram of a depth Hₐ of interface particles embedded in a lithium supplementation layer; and

FIG. 7 is a schematic diagram of a height difference H_{c} between an upper surface and a lower surface of an interface layer.

### DETAILED DESCRIPTION

The following clearly and completely describes the technical solutions in the embodiments of this application with reference to the accompanying drawings in the embodiments of this application. Apparently, the described embodiments are merely some but not all embodiments of this application. All other embodiments obtained by those skilled in the art based on this application fall within the scope of protection of this application.

It should be noted that, in the specific embodiments of this application, a lithium-ion battery is used as an example of a secondary battery to explain this application, but the secondary battery of this application is not limited to lithium-ion batteries.

A first aspect of this application provides a preparation method of lithium supplementation composite layer, including the following steps:
(1) under conditions of ambient temperature≤30° C. and humidity≤1.7%, applying a lithium metal powder slurry onto a support layer, followed by drying and rolling, to form a lithium supplementation layer; or rolling lithium foil and/or lithium alloy foil onto a support layer to form a lithium supplementation layer; or applying a molten lithium or lithium alloy slurry onto a support layer, followed by cooling and rolling, to form a lithium supplementation layer; where a rolling pressure P1 is 0.1 T/10 mm to 2 T/10 mm; specifically, a rolling pressure P11 for rolling after the lithium metal powder slurry is applied onto the support layer is 0.1 T/10 mm to 2 T/10 mm; a rolling pressure P12 for rolling the lithium foil and/or lithium alloy foil onto the support layer is 0.1 T/10 mm to 2 T/10 mm; and a rolling pressure P13 for rolling after the molten lithium or lithium alloy slurry is applied onto the support layer is 0.1 T/10 mm to 2 T/10 mm; and
(2) under conditions of ambient temperature≤30° C. and humidity≤1.7%, applying interface particles onto a surface of the lithium supplementation layer to form an interface layer, followed by rolling, to form a lithium supplementation composite layer, where a rolling pressure P2 is 0.1 T/10 mm to 2 T/10 mm, and preferably, the rolling pressure P2 is 0.2 T/10 mm to 0.8 T/10 mm; a rolling temperature T1 is 25° C. to 170° C., and preferably, the rolling temperature T1 is 50° C. to 120° C.; and a rolling rest time t1 is 5 min to 50 min, and preferably, the rolling rest time t1 is 10 min to 30 min.

For example, P1 may be 0.1 T/10 mm, 0.2 T/10 mm, 0.4 T/10 mm, 0.6 T/10 mm, 0.8 T/10 mm, 1 T/10 mm, 1.2 T/10 mm, 1.4 T/10 mm, 1.6 T/10 mm, 1.8 T/10 mm, 2 T/10 mm, or in a range defined by any two of the above values. P11 may be 0.1 T/10 mm, 0.2 T/10 mm, 0.4 T/10 mm, 0.6 T/10 mm, 0.8 T/10 mm, 1 T/10 mm, 1.2 T/10 mm, 1.4 T/10 mm, 1.6 T/10 mm, 1.8 T/10 mm, 2 T/10 mm, or in a range defined by any two of the above values. P12 may be 0.1 T/10 mm, 0.2 T/10 mm, 0.4 T/10 mm, 0.6 T/10 mm, 0.8 T/10 mm, 1 T/10 mm, 1.2 T/10 mm, 1.4 T/10 mm, 1.6 T/10 mm, 1.8 T/10 mm, 2 T/10 mm, or in a range defined by any two of the above values. P13 may be 0.1 T/10 mm, 0.2 T/10 mm, 0.4 T/10 mm, 0.6 T/10 mm, 0.8 T/10 mm, 1 T/10 mm, 1.2 T/10 mm, 1.4 T/10 mm, 1.6 T/10 mm, 1.8 T/10 mm, 2 T/10 mm, or in a range defined by any two of the above values. P2 may be 0.1 T/10 mm, 0.2 T/10 mm, 0.4 T/10 mm, 0.6 T/10 mm, 0.8 T/10 mm, 1 T/10 mm, 1.2 T/10 mm, 1.4 T/10 mm, 1.6 T/10 mm, 1.8 T/10 mm, 2 T/10 mm, or in a range defined by any two of the above values. T1 may be 25° C., 40° C., 50° C., 60° C., 80° C., 100° C., 120° C., 140° C., 160° C., 170° C., or in a range defined by any two of the above values. t1 may be 5 min, 9 min, 10 min, 15 min, 19 min, 20 min, 25 min, 29 min, 30 min, 35 min, 39 min, 40 min, 45 min, 49 min, 50 min, or in a range defined by any two of the above values.

In this application, the lithium supplementation layer may be formed by applying a lithium metal powder slurry, followed by rolling; or the lithium supplementation layer may be formed by rolling lithium foil and/or lithium alloy foil onto the support layer; or the lithium supplementation layer may be formed by applying a molten lithium or lithium alloy slurry onto the support layer, followed by cooling and rolling. In this application, the lithium alloy foil may include, but is not limited to, lithium-aluminum alloy, and the lithium alloy in the molten lithium alloy slurry may include, but is not limited to, lithium-aluminum alloy. This application does not specifically limit the coating method for applying interface particles to the surface of the lithium supplementation layer, as long as the purpose of this application can be achieved. For example, the interface particles can be applied onto the surface of the lithium supplementation layer by electrostatic spraying, roller coating, or wiping.

In an embodiment of this application, the lithium supplementation composite layer includes the support layer, the lithium supplementation layer, and the interface layer, where the lithium supplementation layer is disposed between the support layer and the interface layer, the interface layer includes the interface particles, and the lithium supplementation layer includes at least one of lithium foil or lithium alloy foil. Specifically, as shown in FIG. 1, the lithium supplementation composite layer 10 includes a support layer 11, a lithium supplementation layer 12, and an interface layer 13, where the lithium supplementation layer 12 is disposed between the support layer 11 and the interface layer 13, the interface layer 13 includes the interface particles, and the lithium supplementation layer 12 includes at least one of lithium foil or lithium alloy foil.

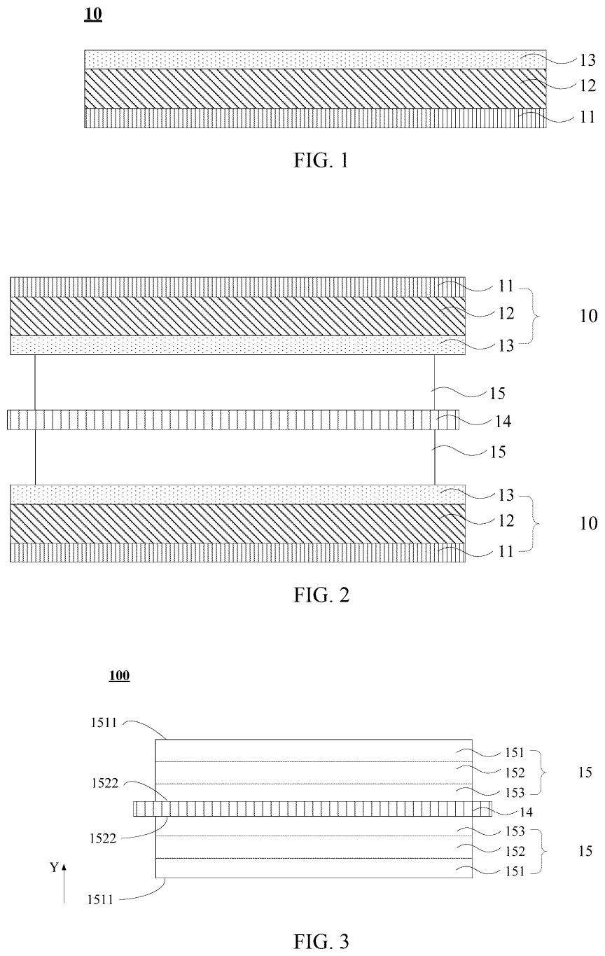

Using the preparation method of lithium supplementation composite layer provided in this application to prepare the lithium supplementation composite layer, the lithium supplementation composite layer includes the support layer, the lithium supplementation layer, and the interface layer, the lithium supplementation layer being disposed between the support layer and the interface layer. The interface layer possesses electronic and ionic conductivity. The interface layer is brought into contact with the negative electrode material layer, as shown in FIG. 2, the interface layer 13 is brought into contact with the negative electrode material layer 15 disposed on each of the two surfaces of the negative electrode current collector 14. It can be understood that the “negative electrode material layer 15” refers to the negative electrode material layer of a negative electrode plate that has not been prelithiated. An internal short circuit is formed between the lithium supplementation layer and the negative electrode material layer, and lithium atoms in the lithium supplementation layer undergo an oxidation reaction, losing electrons to generate lithium ions. Electrons and lithium ions are transferred through the interface layer to the surface or interior of the negative electrode material layer, and the electrons and lithium ions undergo a reduction reaction in the negative electrode material layer to form lithiated compounds, implementing the prelithiation process of the negative electrode material layer. Since an interface layer is disposed between the lithium supplementation layer and the negative electrode material layer, the likelihood of the lithium supplementation layer adhering to the surface of the negative electrode material layer can be reduced, thereby reducing the impact of side reactions caused by the high activity of lithium metal in the lithium supplementation layer on the electrochemical performance of the secondary battery. After the prelithiation treatment ends, the lithium supplementation composite layer is peeled off from the negative electrode plate to obtain a prelithiated negative electrode plate. This peeling process can reduce the impact of side reactions, caused by elemental lithium metal in the lithium supplementation layer remaining on the surface of the negative electrode material layer and entering the secondary battery, on the electrochemical performance of the secondary battery. The foregoing method is used to prepare the lithium supplementation composite layer, followed by prelithiation treatment of the negative electrode plate, facilitating lithium supplementation of the negative electrode plate. The resulting prelithiated negative electrode plate, when applied to a secondary battery, can improve the initial Coulombic efficiency of the secondary battery, reduce cycling capacity degradation, and enhance the energy density of the secondary battery.

In an embodiment of this application, the interface particles include at least one of a conductive agent or a lithiation material; the conductive agent includes at least one of conductive carbon black, carbon fiber, graphene, or carbon nanotubes; and the lithiation material includes at least one of artificial graphite, natural graphite, hard carbon, silicon-carbon material, or silicon-oxygen material. In this application, the conductive carbon black may include, but is not limited to, at least one of Super P, acetylene black, or Ketjen black; the carbon fiber may include, but is not limited to, at least one of vapor-grown carbon fiber (VGCF) or carbon nanofiber; and the carbon nanotubes may include, but are not limited to, at least one of single-walled carbon nanotubes, multi-walled carbon nanotubes, or few-walled carbon nanotubes. The use of the foregoing interface particles allows the interface layer to have good electron and ion conductivity, which facilitates the rapid transfer of electrons and lithium ions through the interface layer to the surface or interior of the negative electrode material layer during prelithiation, facilitating further lithium supplementation to the negative electrode plate. This can further improve the initial Coulombic efficiency of the secondary battery, further reduce cycling capacity degradation, and further enhance the energy density of the secondary battery.

In an embodiment of this application, a thickness H1 of the interface layer is 0.1 μm to 50 μm, and preferably, the thickness H1 of the interface layer is 1 μm to 20 μm. For example, the value of H1 may be 0.1, 0.5, 1, 5, 10, 15, 20, 25, 30, 35, 40, 45, 50, or in a range defined by any two of the above values. Lithium atoms lose electrons in the lithium supplementation layer to form lithium ions, and the electrons and lithium ions are transferred through the interface layer to the surface or interior of the negative electrode material layer. By controlling the thickness of the interface layer within the range of this application, the interface layer has an appropriate thickness, the transmission distance of electrons and lithium ions is moderate, and electrons and lithium ions can effectively recombine to form lithiated compounds, facilitating further lithium supplementation of the negative electrode plate. This further improves the initial Coulombic efficiency of the secondary battery, further reduces cycling capacity degradation, and further enhances the energy density of the secondary battery.

In an embodiment of this application, a coverage ratio s1 of the interface particles on the lithium supplementation layer is 50% to 100%, and preferably, the coverage ratio s1 of the interface particles on the lithium supplementation layer is 80% to 100%. For example, the value of s1 may be 50%, 55%, 60%, 65%, 70%, 75%, 80%, 85%, 90%, 95%, 100%, or in a range defined by any two of the above values. The coverage ratio of the interface layer on the lithium supplementation layer affects the uniformity of lithium supplementation in the negative electrode material layer, to be specific, a higher coverage ratio of the interface layer on the lithium supplementation layer leads to a higher uniformity of lithium supplementation in the negative electrode material layer. When the coverage ratio of the interface particles on the lithium supplementation layer is within the range of this application, the coverage ratio of the interface particles on the lithium supplementation layer is relatively high, resulting in a high uniformity of lithium supplementation in the negative electrode material layer. This can further improve the initial Coulombic efficiency of the secondary battery, further reduce cycling capacity degradation, and further enhance the energy density of the secondary battery.

In an embodiment of this application, the interface particles are embedded in the lithium supplementation layer, and a depth of the interface particles embedded in the lithium supplementation layer accounts for 10% to 95% of the thickness of the interface layer, and preferably, the depth of the interface particles embedded in the lithium supplementation layer accounts for 20% to 70% of the thickness of the interface layer. For example, the proportion of the depth of the interface particles embedded in the lithium supplementation layer to the thickness of the interface layer may be 10%, 15%, 20%, 25%, 30%, 35%, 40%, 45%, 50%, 55%, 60%, 65%, 70%, 75%, 80%, 85%, 90%, 95%, or in a range defined by any two of the above values. When the interface particles are embedded in the lithium supplementation layer and the proportion of the depth of the interface particles embedded in the lithium supplementation layer to the thickness of the interface layer is within the range of this application, lithium inside the lithium supplementation layer can be better promoted to participate in the oxidation reaction, thereby better transferring the lithium inside the lithium supplementation layer to the negative electrode material layer, and facilitating further lithium supplementation of the negative electrode plate. This can further improve the initial Coulombic efficiency of the secondary battery, further reduce cycling capacity degradation, and further enhance the energy density of the secondary battery. This also facilitates the repeated use of the lithium supplementation composite layer.

In an embodiment of this application, a thickness H2 of the lithium supplementation layer is 0.001 mm to 1 mm, and preferably, the thickness H2 of the lithium supplementation layer is 0.005 mm to 0.1 mm. For example, the value of H2 may be 0.001, 0.003, 0.005, 0.007, 0.009, 0.01, 0.03, 0.05, 0.07, 0.09, 0.1, 0.3, 0.5, 0.7, 0.9, 1, or in a range defined by any two of the above values.

In an embodiment of this application, the support layer includes at least one of metal foil, polyethylene terephthalate film, polypropylene film, or polyethylene film, and the metal foil includes copper foil, nickel foil, steel foil, or copper-nickel alloy foil. By using such support layer, the support layer can provide good support for the lithium supplementation layer and the interface layer, improving the mechanical strength of the lithium supplementation composite layer. This enables the lithium supplementation composite layer to be smoothly peeled off from the surface of the negative electrode material layer after lithium supplementation, reducing the likelihood of fracture in the lithium supplementation composite layer, and facilitating lithium supplementation of the negative electrode plate. This can further improve the initial Coulombic efficiency of the secondary battery, further reduce cycling capacity degradation, and further enhance the energy density of the secondary battery.

This application does not specifically limit a thickness H3 of the support layer, as long as the purpose of this application can be achieved. For example, a thickness H3 of the support layer may be 3 μm to 50 μm, and preferably, the thickness H3 of the support layer may be 5 μm to 20 μm.

A second aspect of this application provides a lithium supplementation method, including the following steps:
drying a negative electrode plate until a water content is less than or equal to 500 ppm, where the negative electrode plate includes a negative electrode current collector and a negative electrode material layer disposed on at least one surface of the negative electrode current collector; it can be understood that the negative electrode plate refers to a negative electrode plate that has not been prelithiated; under conditions of ambient temperature of 25° C. to 180° C. and humidity≤1.7%, laminating the lithium supplementation composite layer according to any one of the foregoing embodiments with the negative electrode plate to bring the interface layer into contact with the negative electrode material layer, performing prelithiation treatment, where an interface pressure P3 between the interface layer and the negative electrode material layer is 0.1 MPa to 2 MPa, and preferably, the interface pressure P3 between the interface layer and the negative electrode material layer is 0.2 MPa to 1.0 MPa; a lamination time t2 between the interface layer and the negative electrode material layer is 0.5 h to 72 h, and preferably, the lamination time t2 between the interface layer and the negative electrode material layer is 1 h to 48 h; and a lamination temperature T2 between the interface layer and the negative electrode material layer is 50° C. to 180° C., and preferably, the lamination temperature T2 between the interface layer and the negative electrode material layer is 60° C. to 160° C.; and after the prelithiation treatment ends, peeling off the lithium supplementation composite layer from the negative electrode plate to form a prelithiated negative electrode plate.

This application does not specifically limit the method of laminating the lithium supplementation composite layer with the negative electrode plate, as long as the purpose of this application can be achieved. For example, the method of laminating the lithium supplementation composite layer with the negative electrode plate may be winding into a roll or pressing into a sheet. This application does not specifically limit the method for controlling the interface pressure of the lamination, as long as the purpose of this application can be achieved. For example, when the lithium supplementation composite layer and the negative electrode plate are wound into a roll, the interface pressure between the interface layer and the negative electrode material layer can be controlled by adjusting the winding tension. For example, when the lithium supplementation composite layer and the negative electrode plate are pressed into a sheet, the interface pressure between the interface layer and the negative electrode material layer can be controlled by adjusting the pressing pressure.

For example, P3 may be 0.1 MPa, 0.2 MPa, 0.4 MPa, 0.6 MPa, 0.8 MPa, 1.0 MPa, 1.2 MPa, 1.4 MPa, 1.6 MPa, 1.8 MPa, 2 MPa, or in a range defined by any two of the above values. t2 may be 0.5 h, 1 h, 5 h, 10 h, 15 h, 20 h, 25 h, 30 h, 35 h, 40 h, 45 h, 48 h, 50 h, 55 h, 60 h, 65 h, 70 h, 72 h, or in a range defined by any two of the above values. T2 may be 50° C., 60° C., 70° C., 80° C., 90° C., 100° C., 110° C., 120° C., 130° C., 140° C., 150° C., 160° C., 170° C., 180° C., or in a range defined by any two of the above values.

The preparation method of lithium supplementation composite layer provided in this application is used to prepare the lithium supplementation composite layer, and then the lithium supplementation method provided in this application is used to prepare the prelithiated negative electrode plate, facilitating lithium supplementation of the negative electrode plate. The resulting prelithiated negative electrode plate, when applied to a secondary battery, can improve the initial Coulombic efficiency of the secondary battery, reduce cycling capacity degradation, and enhance the energy density of the secondary battery.

A third aspect of this application provides a prelithiated negative electrode plate prepared using the lithium supplementation method according to any one of the foregoing embodiments, where the prelithiated negative electrode plate includes a negative electrode current collector and a negative electrode material layer. Along a thickness direction of the negative electrode plate, the negative electrode material layer includes a first surface and a second surface opposite each other. From the first surface to the second surface, the negative electrode material layer sequentially includes a first region, a second region, and a third region, the third region being located on a surface of the negative electrode current collector. A thickness of the first region accounts for ⅓ of a thickness of the negative electrode material layer, a thickness of the second region accounts for ⅓ of the thickness of the negative electrode material layer, and a thickness of the third region accounts for ⅓ of the thickness of the negative electrode material layer. Based on a mass of the first region, a mass percentage of lithium element is W1, based on a mass of the second region, a mass percentage of lithium element is W2, and based on a mass of the third region, a mass percentage of lithium element is W3, where W1>W2>W3, 1.01≤W1/W2≤2.0, and 1.01≤W2/W3≤2.0. For example, W1/W2 may be 1.01, 1.1, 1.2, 1.3, 1.4, 1.5, 1.6, 1.7, 1.8, 1.9, 2.0, or in a range defined by any two of the above values; and W2/W3 may be 1.01, 1.1, 1.2, 1.3, 1.4, 1.5, 1.6, 1.7, 1.8, 1.9, 2.0, or in a range defined by any two of the above values. In this application, the prelithiated negative electrode plate includes a negative electrode current collector and a negative electrode material layer disposed on at least one surface of the negative electrode current collector, where the “negative electrode material layer disposed on at least one surface of the negative electrode current collector” means that the negative electrode material layer may be disposed on one surface of the negative electrode current collector along its thickness direction, or may be disposed on both surfaces of the negative electrode current collector along its thickness direction. It should be noted that the “surface” herein may be the entire region of the negative electrode current collector or a partial region of the negative electrode current collector, which is not specifically limited in this application, as long as the purpose of this application can be achieved. For example, as shown in FIG. 3, the prelithiated negative electrode plate 100 includes a negative electrode current collector 14 and negative electrode material layers 15 disposed on two surfaces of the negative electrode current collector 14, where along a thickness direction of the negative electrode plate, that is, a direction Y, the negative electrode material layer 15 includes a first surface 1511 and a second surface 1522 opposite each other. From the first surface 1511 to the second surface 1522, the negative electrode material layer 15 sequentially includes a first region 151, a second region 152, and a third region 153, the third region 153 being located on a surface of the negative electrode current collector 14. A thickness of the first region 151 accounts for ⅓ of a thickness of the negative electrode material layer 15, a thickness of the second region 152 accounts for ⅓ of the thickness of the negative electrode material layer 15, and a thickness of the third region 153 accounts for ⅓ of the thickness of the negative electrode material layer 15. Based on a mass of the first region, a mass percentage of lithium element is W1, based on a mass of the second region, a mass percentage of lithium element is W2, and based on a mass of the third region, a mass percentage of lithium element is W3, where W1>W2>W3, 1.01≤W1/W2≤2.0, and 1.01≤W2/W3≤ 2.0. It can be understood that in the “prelithiated negative electrode plate 100 includes a negative electrode current collector 14 and negative electrode material layers 15 disposed on both surfaces of the negative electrode current collector 14”, the “negative electrode material layer 15” refers to a negative electrode material layer after prelithiation treatment of a negative electrode plate that has not been prelithiated.

This application does not specifically limit the method for controlling the mass percentages of lithium element in the first region, second region, and third region of the negative electrode material layer in the prelithiated negative electrode plate, as long as the purpose of this application can be achieved. For example, the mass percentages of lithium element in the first region, second region, and third region of the negative electrode material layer in the prelithiated negative electrode plate can be controlled by adjusting the prelithiation method. For example, the negative electrode plate can be prelithiated by laminating the lithium supplementation composite layer with the negative electrode plate. For example, the lithium supplementation amount and lithium supplementation speed can be controlled by adjusting the interface pressure, lamination time, and lamination temperature between the interface layer of the lithium supplementation composite layer and the negative electrode material layer, thereby controlling the mass percentages of lithium element in the first region, second region, and third region of the negative electrode material layer in the prelithiated negative electrode plate.

This application does not specifically limit the method for controlling the value of W1/W2, as long as the purpose of this application can be achieved. For example, the value of W1/W2 can be controlled by adjusting the respective values of W1 and W2, with the methods for controlling W1 and W2 as described above. This application does not specifically limit the method for controlling the value of W2/W3, as long as the purpose of this application can be achieved. For example, the value of W2/W3 can be controlled by adjusting the respective values of W2 and W3, with the methods for controlling W2 and W3 as described above.

The inventors have found through research that a non-prelithiated negative electrode plate is taken, where the non-prelithiated negative electrode plate includes a negative electrode current collector and a negative electrode material layer, and prelithiation treatment is performed on the non-prelithiated negative electrode plate, to obtain a prelithiated negative electrode plate. The negative electrode material layer includes a negative electrode active material, where the negative electrode active material includes at least one of a carbon material or a silicon-containing substance. Within the same prelithiation treatment time, different negative electrode active materials have different lithium supplementation efficiencies, with the silicon-containing substance having a lower lithium supplementation amount and the carbon material having a higher lithium supplementation amount. Therefore, depending on the types of the negative electrode active materials, the lithium supplementation amounts in the negative electrode active materials differ, leading to different lithium supplementation amounts in the prelithiated negative electrode plate. For the prelithiated negative electrode plate, along a thickness direction of the negative electrode plate, the negative electrode material layer includes a first surface and a second surface opposite each other; and from the first surface to the second surface, the negative electrode material layer sequentially includes a first region, a second region, and a third region, the third region being located on a surface of the negative electrode current collector. The mass percentages of lithium element in the first region, second region, and third region satisfies: the mass percentage of lithium element in the first region>the mass percentage of lithium element in the second region>the mass percentage of lithium element in the third region, and a ratio of the mass percentage of lithium element in the first region to the mass percentage of lithium element in the second region, and a ratio of the mass percentage of lithium element in the second region to the mass percentage of lithium element in the third region are within the ranges of this application, the mass percentages of lithium element in the first region, second region, and third region are all non-zero, and the lithium element in the negative electrode material layer has a gradient distribution along the thickness direction, resulting in a prelithiated negative electrode plate with a high lithium supplementation amount. The foregoing prelithiated negative electrode plate, when applied to a secondary battery, can improve the initial Coulombic efficiency of the secondary battery, reduce cycling capacity degradation, and enhance the energy density of the secondary battery.

In an embodiment of this application, the negative electrode material layer includes a negative electrode active material, where the negative electrode active material includes at least one of a carbon material or a silicon-containing substance, the carbon material includes at least one of a graphite material or hard carbon, and the silicon-containing substance includes at least one of a silicon-carbon material or a silicon-oxygen material. In this application, the graphite material includes at least one of artificial graphite or natural graphite; the silicon-carbon material is a silicon-carbon composite material, and based on a mass of the silicon-carbon composite material, a mass percentage w_{Si} of silicon element is 30% to 70%, and a mass percentage w_{C} of carbon element is 30% to 70%. This application does not specifically limit the silicon-carbon composite material, as long as the purpose of this application can be achieved. For example, the silicon-carbon composite material may be a composite material obtained by deposition. For example, the silicon-carbon composite material may be a silicon material deposited on a carbon framework, or a carbon material deposited on a silicon framework. The silicon-oxygen material includes SiOₓ, where 0<x<2. For example, the silicon-oxygen material may include silicon monoxide (SiO, with a molar ratio of silicon to oxygen of 1:1). When the negative electrode material layer includes the negative electrode active material, and the negative electrode active material includes the foregoing substance, the prelithiated negative electrode plate has a relatively high lithium supplementation amount, and the prepared secondary battery has a high initial Coulombic efficiency, low cycling capacity degradation, and high energy density.

In this application, the negative electrode active material includes the carbon material and the silicon-containing substance, and based on the mass of the negative electrode active material, the mass percentage W_{Si} of the silicon-containing substance is 5% to 100%, and the mass percentage Wc of the carbon material is 0 to 95%. For example, the mass percentage of the silicon-containing substance may be 5%, 10%, 20%, 30%, 40%, 50%, 60%, 70%, 80%, 90%, 100%, or in a range defined by any two of the above values; and the mass percentage of the carbon material may be 0, 5%, 10%, 20%, 30%, 40%, 50%, 60%, 70%, 80%, 90%, 95%, or in a range defined by any two of the above values.

In an embodiment of this application, the negative electrode active material includes only the silicon-containing substance, and based on a mass of the negative electrode material layer, a mass percentage of silicon element in the negative electrode material layer is w1, where 18.6%≤w1≤63.5%, 11.5%≤W1≤18.4%, 9.2%≤W2<11.5%, and 4.6%≤W3<9.2%. For example, w1 may be 18.6%, 25.5%, 30.5%, 37.5%, 38.5%, 39.5%, 40.5%, 41.5%, 42.5%, 43.5%, 44.5%, 45.5%, 46.5%, 47.5%, 55.5%, 63.5%, or in a range defined by any two of the above values; W1 may be 11.5%, 12.5%, 13.5%, 14.5%, 15.5%, 16.5%, 17.5%, 18.4%, or in a range defined by any two of the above values; W2 may be 9.2%, 9.4%, 9.6%, 9.8%, 10%, 10.2%, 10.4%, 10.6%, 10.8%, 11%, 11.2%, 11.4%, or in a range defined by any two of the above values; and W3 may be 4.6%, 5%, 5.5%, 6%, 6.5%, 7%, 7.5%, 8%, 8.5%, 9%, 9.1%, or in a range defined by any two of the above values. The negative electrode active material includes only the silicon-containing substance, and the silicon-containing substance has a relatively high specific capacity. When the mass percentage w1 of silicon element in the negative electrode material layer, W1, W2, and W3 are within the ranges of this application, the negative electrode material layer has a high capacity, high ionic conductivity, and high electronic conductivity, and the prelithiated negative electrode plate has a relatively high lithium supplementation amount. The foregoing prelithiated negative electrode plate, when applied to a secondary battery, can further improve the initial Coulombic efficiency of the secondary battery, further reduce cycling capacity degradation, and further enhance the energy density of the secondary battery.

In an embodiment of this application, the negative electrode active material includes the carbon material and the silicon-containing substance, and based on a mass of the negative electrode material layer, a mass percentage of silicon element in the negative electrode material layer is w1, where 1.1%≤w1≤3.4%, 0.38%≤W1≤0.60%, 0.30%≤W2<0.38%, and 0.15%≤W3<0.30%. For example, w1 may be 1.1%, 1.5%, 1.9%, 2%, 2.1%, 2.2%, 2.3%, 2.4%, 2.5%, 2.6%, 2.7%, 2.8%, 2.9%, 3%, 3.1%, 3.2%, 3.4%, or in a range defined by any two of the above values; W1 may be 0.38%, 0.4%, 0.42%, 0.44%, 0.46%, 0.48%, 0.5%, 0.52%, 0.54%, 0.56%, 0.58%, 0.60%, or in a range defined by any two of the above values; W2 may be 0.30%, 0.31%, 0.32%, 0.33%, 0.34%, 0.35%, 0.36%, 0.37%, or in a range defined by any two of the above values; and W3 may be 0.15%, 0.17%, 0.19%, 0.2%, 0.21%, 0.23%, 0.25%, 0.27%, 0.29%, or in a range defined by any two of the above values. The negative electrode active material includes the carbon material and the silicon-containing substance, and within the same prelithiation treatment time, different negative electrode active materials have different lithium supplementation efficiencies, with the silicon-containing substance having a lower lithium supplementation amount and the carbon material having a higher lithium supplementation amount, which affects the lithium supplementation amount in the prelithiated negative electrode plate. When the mass percentage w1 of silicon element in the negative electrode material layer, W1, W2, and W3 are within the ranges of this application, the carbon material and the silicon-containing substance have appropriate mass percentages, and the negative electrode active material has a high capacity and a high lithium supplementation amount, enabling the prelithiated negative electrode plate to have a high capacity and a high lithium supplementation amount. The foregoing prelithiated negative electrode plate, when applied to a secondary battery, can further improve the initial Coulombic efficiency of the secondary battery, further reduce cycling capacity degradation, and further enhance the energy density of the secondary battery.

In an embodiment of this application, the negative electrode active material includes the carbon material and the silicon-containing substance, and based on a mass of the negative electrode material layer, a mass percentage of silicon element in the negative electrode material layer is w1, where 3.3%≤w1≤10.2%, 2.8%≤W1≤4.5%, 2.2%≤W2<2.8%, and 1.1%≤W3<2.2%. For example, w1 may be 3.3%, 4%, 4.5%, 5%, 5.7%, 6%, 6.5%, 7%, 7.5%, 8%, 8.5%, 9%, 9.5%, 9.6%, 10%, 10.2%, or in a range defined by any two of the above values; W1 may be 2.8%, 3%, 3.2%, 3.4%, 3.6%, 3.8%, 4%, 4.2%, 4.4%, 4.5%, or in a range defined by any two of the above values; W2 may be 2.2%, 2.3%, 2.4%, 2.5%, 2.6%, 2.7%, or in a range defined by any two of the above values; and W3 may be 1.1%, 1.2%, 1.3%, 1.4%, 1.5%, 1.6%, 1.7%, 1.8%, 1.9%, 2%, 2.1%, or in a range defined by any two of the above values. The negative electrode active material includes the carbon material and the silicon-containing substance, and within the same prelithiation treatment time, different negative electrode active materials have different lithium supplementation efficiencies, with the silicon-containing substance having a lower lithium supplementation amount and the carbon material having a higher lithium supplementation amount, which affects the lithium supplementation amount in the prelithiated negative electrode plate. When the mass percentage w1 of silicon element in the negative electrode material layer, W1, W2, and W3 are within the ranges of this application, the carbon material and the silicon-containing substance have appropriate mass percentages, and the negative electrode active material has a high capacity and a high lithium supplementation amount, enabling the prelithiated negative electrode plate to have a high capacity and a high lithium supplementation amount. The foregoing prelithiated negative electrode plate, when applied to a secondary battery, can further improve the initial Coulombic efficiency of the secondary battery, further reduce cycling capacity degradation, and further enhance the energy density of the secondary battery.

In an embodiment of this application, a porosity of the first region is S1, a porosity of the second region is S2, and a porosity of the third region is S3, where S1>S2>S3. When S1, S2, and S3 satisfy the above relationship, the migration of lithium ions along the thickness direction of the negative electrode plate is facilitated, improving the kinetic performance of the negative electrode plate. This application does not specifically limit the method for controlling the porosities of the first region, second region, and third region of the negative electrode material layer in the prelithiated negative electrode plate, as long as the purpose of this application can be achieved. For example, the lithium supplementation amount and lithium supplementation speed can be controlled by adjusting the interface pressure, lamination time, and lamination temperature between the interface layer of the lithium supplementation composite layer and the negative electrode material layer, thereby controlling the lithium supplementation amounts in the first region, second region, and third region of the negative electrode material layer in the prelithiated negative electrode plate, and further controlling the porosities of the first region, second region, and third region.

In an embodiment of this application, 1.01≤S1/S2≤1.5, and 1.01≤S2/S3≤1.5. For example, S1/S2 may be 1.01, 1.1, 1.2, 1.3, 1.4, 1.5, or in a range defined by any two of the above values; and S2/S3 may be 1.01, 1.1, 1.2, 1.3, 1.4, 1.5, or in a range defined by any two of the above values. When the values of S1/S2 and S2/S3 are within the ranges of this application, the porosity of the first region>the porosity of the second region>the porosity of the third region, which facilitates the migration of lithium ions along the thickness direction of the negative electrode plate, further improving the kinetic performance of the negative electrode plate. This application does not specifically limit the method for controlling the value of S1/S2, as long as the purpose of this application can be achieved. For example, the value of S1/S2 can be controlled by adjusting the respective values of S1 and S2, with the methods for controlling S1 and S2 as described above. This application does not specifically limit the method for controlling the value of S2/S3, as long as the purpose of this application can be achieved. For example, the value of S2/S3 can be controlled by adjusting the respective values of S2 and S3, with the methods for controlling S2 and S3 as described above.

In an embodiment of this application, the negative electrode active material includes only the silicon-containing substance, and based on a mass of the negative electrode material layer, a mass percentage of silicon element in the negative electrode material layer is w1, where 18.6%≤w1≤63.5%, 42.1%≤S1≤57.0%, 38.0%≤S2<42.1%, and 25.0%≤S3<38.0%. For example, w1 may be 18.6%, 25.5%, 37.5%, 38.5%, 39.5%, 40.5%, 41.5%, 42.5%, 43.5%, 44.5%, 45.5%, 46.5%, 47.5%, 55.5%, 63.5%, or in a range defined by any two of the above values; S1 may be 42.1%, 44%, 46%, 48%, 50%, 52%, 54%, 56%, 57.0%, or in a range defined by any two of the above values; S2 may be 38.0%, 38.5%, 39.0%, 39.5%, 40.0%, 40.5%, 41.0%, 41.5%, 42.0%, or in a range defined by any two of the above values; and S3 may be 25.0%, 26.0%, 27.0%, 28.0%, 29.0%, 30.0%, 31.0%, 32.0%, 33.0%, 34.0%, 35.0%, 36.0%, 37.0%, 37.9%, or in a range defined by any two of the above values. The negative electrode active material includes only the silicon-containing substance, and the silicon-containing substance has a relatively high specific capacity. When the mass percentage w1 of silicon element in the negative electrode material layer, S1, S2, and S3 are within the ranges of this application, the migration of lithium ions along the thickness direction of the negative electrode plate is facilitated, further improving the kinetic performance of the negative electrode plate while ensuring that the negative electrode plate has a high capacity.

In an embodiment of this application, the negative electrode active material includes the carbon material and the silicon-containing substance, and based on a mass of the negative electrode material layer, a mass percentage of silicon element in the negative electrode material layer is w1, where 1.1%≤w1≤3.4%, 26.3%≤S1≤35.5%, 23.7%≤S2<26.3%, and 15.8%≤S3<23.7%. For example, w1 may be 1.1%, 1.9%, 2%, 2.1%, 2.2%, 2.3%, 2.4%, 2.5%, 2.6%, 2.7%, 2.8%, 2.9%, 3%, 3.1%, 3.2%, 3.4%, or in a range defined by any two of the above values; S1 may be 26.3%, 27.3%, 28.3%, 29.3%, 30.3%, 31.3%, 32.3%, 33.3%, 34.3%, 35.3%, 35.5%, or in a range defined by any two of the above values; S2 may be 23.7%, 24%, 24.7%, 25%, 25.7%, 26%, 26.2%, or in a range defined by any two of the above values; and S3 may be 15.8%, 16.8%, 17.8%, 18.8%, 19.8%, 20.8%, 21.8%, 22.8%, 23.6%, or in a range defined by any two of the above values. The negative electrode active material includes the carbon material and the silicon-containing substance, which facilitates further improvement of the specific capacity and lithium supplementation amount of the negative electrode active material. When the mass percentage w1 of silicon element in the negative electrode material layer, S1, S2, and S3 are within the ranges of this application, the migration of lithium ions along the thickness direction of the negative electrode plate is facilitated, further improving the kinetic performance of the negative electrode plate while ensuring that the negative electrode plate has a high capacity.

In an embodiment of this application, the negative electrode active material includes the carbon material and the silicon-containing substance, and based on a mass of the negative electrode material layer, a mass percentage of silicon element in the negative electrode material layer is w1, where 3.3%≤w1≤10.2%, 31.6%≤S1≤42.6%, 28.4%≤S2<31.6%, and 18.9%≤S3<28.4%. For example, w1 may be 3.3%, 4.5%, 5.7%, 6%, 6.5%, 7%, 7.5%, 8%, 8.5%, 9%, 9.5%, 9.6%, 10%, 10.2%, or in a range defined by any two of the above values; S1 may be 31.6%, 32.6%, 33.6%, 34.6%, 35.6%, 36.6%, 37.6%, 38.6%, 39.6%, 40.6%, 41.6%, 42.6%, or in a range defined by any two of the above values; S2 may be 28.4%, 29%, 29.4%, 30%, 30.4%, 31%, 31.4%, 31.5%, or in a range defined by any two of the above values; and S3 may be 18.9%, 19.9%, 20.9%, 21.9%, 22.9%, 23.9%, 24.9%, 25.9%, 26.9%, 27.9%, 28.3%, or in a range defined by any two of the above values. The negative electrode active material includes the carbon material and the silicon-containing substance, which facilitates further improvement of the specific capacity and lithium supplementation amount of the negative electrode active material. When the mass percentage w1 of silicon element in the negative electrode material layer, S1, S2, and S3 are within the ranges of this application, the migration of lithium ions along the thickness direction of the negative electrode plate is facilitated, further improving the kinetic performance of the negative electrode plate while ensuring that the negative electrode plate has a high capacity.

In this application, the negative electrode material layer further includes a negative electrode binder and a negative electrode conductive agent. This application does not specifically limit the type of the negative electrode binder, as long as the purpose of this application can be achieved. For example, the negative electrode binder may include at least one of polyacrylate, polyimide, polyamide, polyamideimide, polyvinylidene fluoride, polystyrene-butadiene copolymer (styrene-butadiene rubber, SBR), sodium alginate, polyvinyl alcohol, polytetrafluoroethylene, polyacrylonitrile, sodium carboxymethyl cellulose, potassium carboxymethyl cellulose, lithium carboxymethyl cellulose, lithium polyacrylate, sodium hydroxymethyl cellulose, or potassium hydroxymethyl cellulose. This application does not specifically limit the type of the negative electrode conductive agent, as long as the purpose of this application can be achieved. For example, the negative electrode conductive agent may include, but is not limited to, at least one of conductive carbon black, carbon nanotubes (CNTs), carbon fiber, flake graphite, graphene, metal material, or conductive polymer. The above metal materials may include, but are not limited to, metal powder and/or metal fibers, specifically, the metal may include, but is not limited to, at least one of copper, nickel, aluminum, or silver. The conductive polymer may include, but is not limited to, at least one of polyphenylene derivative, polyaniline, polythiophene, polyacetylene, or polypyrrole. This application does not specifically limit the mass ratio of the negative electrode active material, negative electrode binder, and negative electrode conductive agent in the negative electrode material layer, which can be selected by those skilled in the art according to actual needs, as long as the purpose of this application can be achieved.

This application does not specifically limit the negative electrode current collector, as long as the purpose of this application can be achieved. For example, it may be copper foil, copper alloy foil, nickel foil, stainless steel foil, titanium foil, nickel foam, copper foam, or a composite current collector (for example, a lithium-copper composite current collector, a carbon-copper composite current collector, a nickel-copper composite current collector, or a titanium-copper composite current collector).

This application does not specifically limit the thickness of the negative electrode current collector, as long as the purpose of this application can be achieved. For example, the thickness of the negative electrode current collector may be 4 μm to 20 μm. This application does not specifically limit the thickness of the negative electrode material layer, as long as the purpose of this application can be achieved. For example, the thickness of a single-sided negative electrode material layer may be 30 μm to 250 μm.

A fourth aspect of this application provides a secondary battery including the prelithiated negative electrode plate according to any one of the foregoing embodiments. Therefore, the secondary battery provided in this application has a high initial Coulombic efficiency, low cycling capacity degradation, and high energy density.

In this application, the secondary battery further includes a positive electrode plate. The positive electrode plate includes a positive electrode current collector and a positive electrode material layer disposed on at least one surface of the positive electrode current collector. The “positive electrode material layer disposed on at least one surface of the positive electrode current collector” means that the positive electrode material layer may be disposed on one surface of the positive electrode current collector along its thickness direction, or may be disposed on two surfaces of the positive electrode current collector along its thickness direction. It should be noted that the “surface” herein may be the entire region of the positive electrode current collector or a partial region of the positive electrode current collector, which is not specifically limited in this application, as long as the purpose of this application can be achieved.

This application does not specifically limit the positive electrode current collector, as long as the purpose of this application can be achieved. For example, it may be aluminum foil, aluminum alloy foil, or a composite current collector (for example, an aluminum-carbon composite current collector).

The positive electrode material layer of this application includes a positive electrode active material, where the positive electrode active material includes a substance capable of reversibly intercalating and deintercalating active ions such as lithium ions. The positive electrode material layer may be one layer or multiple layers, and each layer in a multi-layer positive electrode material layer may include the same or different positive electrode active materials. This application does not specifically limit the positive electrode active material, as long as the purpose of this application can be achieved. For example, the positive electrode active material may include, but is not limited to, at least one of lithium nickel cobalt manganese oxide, lithium nickel cobalt aluminum oxide, lithium iron phosphate, lithium-rich manganese-based material, lithium cobalt oxide (LiCoO₂), lithium manganese oxide, lithium manganese iron phosphate, or lithium titanate. The lithium nickel cobalt manganese oxide may include at least one of LiNi_{0.95}Co_{0.03}Mn_{0.02}O₂ (Ni95), LiNi_{0.91}Co_{0.03}Mn_{0.06}O₂ (Ni91), LiNi_{0.8}Co_{0.1}Mn_{0.1}O₂ (NCM811), LiNi_{0.6}Co_{0.2}Mn_{0.2}O₂ (NCM622), LiNi_{0.5}Co_{0.2}Mn_{0.302} (NCM523), or LiNi_{1/3}Co_{1/3}Mn_{1/3}O₂ (NCM111). The positive electrode material layer of this application further includes a positive electrode conductive agent and a positive electrode binder. This application does not specifically limit the positive electrode conductive agent and positive electrode binder in the positive electrode material layer, as long as the purpose of this application can be achieved. For example, the positive electrode conductive agent in the positive electrode material layer may include at least one of the foregoing negative electrode conductive agents; and the positive electrode binder in the positive electrode material layer may include at least one of the foregoing negative electrode binders. This application does not specifically limit the mass ratio of the positive electrode active material, positive electrode conductive agent, and positive electrode binder in the positive electrode material layer, which can be selected by those skilled in the art according to actual needs, as long as the purpose of this application can be achieved.

This application does not specifically limit the thickness of the positive electrode current collector, as long as the purpose of this application can be achieved. For example, the thickness of the positive electrode current collector is 6 μm to 25 μm. This application does not specifically limit the thickness of the positive electrode material layer, as long as the purpose of this application can be achieved. For example, the thickness of a single-sided positive electrode material layer is 25 μm to 250 μm.

In this application, the secondary battery further includes an electrolyte. The electrolyte includes a lithium salt. This application does not specifically limit the type of the lithium salt, and any lithium salts known in the art can be used. For example, the lithium salt may include, but is not limited to, at least one of lithium hexafluorophosphate (LiPF₆), lithium bis(trifluoromethanesulfonyl)imide (LiN(CF₃SO₂)₂, LiTFSI), lithium bis(fluorosulfonyl)imide (Li(N(SO₂F)₂), LiFSI), lithium difluorophosphate (LiPO₂F₂), lithium bis(oxalate) borate (LiB(C₂O₄)₂, LiBOB), or lithium difluoro (oxalate) borate (LiBF₂(C₂O₄), LiDFOB). This application does not specifically limit the mass percentage of the lithium salt in the electrolyte, as long as the purpose of this application can be achieved. The electrolyte further includes a non-aqueous organic solvent. This application does not specifically limit the non-aqueous organic solvent, as long as the purpose of this application can be achieved. For example, the non-aqueous organic solvent may include at least one of carbonate compound, carboxylate compound, ether compound, or another organic solvent. The carbonate compound may include, but is not limited to, at least one of linear carbonate compound, cyclic carbonate compound, or fluorinated carbonate compound. The linear carbonate compound may include, but is not limited to, at least one of dimethyl carbonate (DMC), diethyl carbonate (DEC), dipropyl carbonate (DPC), methyl propyl carbonate (MPC), ethyl propyl carbonate (EPC), or methyl ethyl carbonate (EMC). The cyclic carbonate compound may include, but is not limited to, at least one of ethylene carbonate (EC), vinylene carbonate, propylene carbonate (PC), butylene carbonate (BC), or vinyl ethylene carbonate (VEC). The fluorinated carbonate compound may include, but is not limited to, at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethyl ethylene carbonate. The carboxylate compound may include, but is not limited to, at least one of methyl formate, methyl acetate, ethyl acetate, n-propyl acetate, tert-butyl acetate, methyl propionate, ethyl propionate, or propyl propionate. The ether compound may include, but is not limited to, at least one of dibutyl ether, tetraglyme, diglyme, 1,2-dimethoxyethane, 1,2-diethoxyethane, ethoxymethoxyethane, 2-methyltetrahydrofuran, or tetrahydrofuran. The another organic solvent may include, but is not limited to, at least one of 1,3-propane sultone, dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, or phosphate ester. This application does not specifically limit the mass percentage of the non-aqueous organic solvent in the electrolyte, as long as the purpose of this application can be achieved.

In this application, the secondary battery further includes a separator. The separator is configured to separate the positive electrode plate and the negative electrode plate, preventing internal short circuits in the secondary battery, and allowing electrolyte ions to pass freely without affecting the electrochemical charge-discharge process. This application does not specifically limit the separator, as long as the purpose of this application can be achieved. For example, the material of the separator may include, but is not limited to, at least one of polyolefin (PO) mainly including polyethylene (PE) or polypropylene (PP), polyester (for example, a polyethylene terephthalate (PET) film), cellulose, polyimide (PI), polyamide (PA), spandex, or aramid; and the type of separator may include at least one of woven film, non-woven film, microporous film, composite film, calendered film, or spun film.

In this application, the separator may include a substrate and a surface treatment layer. The substrate may be a non-woven fabric or composite film with a porous structure, and the material of the substrate may include at least one of polyethylene, polypropylene, polyethylene terephthalate, or polyimide. Optionally, a polypropylene porous film, a polyethylene porous film, a polypropylene non-woven fabric, polyethylene non-woven fabric, or a polypropylene-polyethylene-polypropylene porous composite film may be used.

Optionally, the surface treatment layer is disposed on at least one surface of the substrate, and the surface treatment layer may be a polymer layer or an inorganic layer, or a layer formed by mixing a polymer and an inorganic substance. For example, the inorganic layer includes inorganic particles and a separator binder. This application does not specifically limit the inorganic particles. For example, the inorganic particles may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. This application does not specifically limit the separator binder. For example, the separator binder may be at least one of the foregoing negative electrode binders. The polymer layer includes a polymer, and the material of the polymer includes at least one of polyamide, polyacrylonitrile, acrylate polymer, polyacrylic acid, polyvinylpyrrolidone, polyvinyl ether, polyvinylidene fluoride, or vinylidene fluoride-hexafluoropropylene copolymer.

The secondary battery of this application further includes a packaging bag for accommodating the positive electrode plate, separator, prelithiated negative electrode plate, and electrolyte, as well as other components known in the art in the secondary battery. This application does not limit the other components. This application does not specifically limit the packaging bag, and it may be a packaging bag known in the art, as long as the purpose of this application can be achieved.

This application does not specifically limit the type of secondary battery, and it may include any apparatus in which an electrochemical reaction takes place. In this application, the secondary battery may include, but is not limited to, a lithium metal secondary battery, a lithium-ion secondary battery (a lithium-ion battery), a lithium polymer secondary battery, a lithium-ion polymer secondary battery (a lithium-ion polymer battery), or the like.

The preparation process of the secondary battery of this application is well known to those skilled in the art, and is not specifically limited in this application. For example, the preparation process may include, but is not limited to, the following steps: stacking the positive electrode plate, separator, and prelithiated negative electrode plate in order, and performing operations such as winding or folding as needed to obtain an electrode assembly with a wound structure, placing the electrode assembly in a packaging bag, injecting the electrolyte into the packaging bag, and sealing it to obtain a secondary battery; or stacking the positive electrode plate, separator, and prelithiated negative electrode plate in order, and fixing the four corners of the entire resulting stacked structure with tape to obtain an electrode assembly with a stacked structure, placing the electrode assembly in a packaging bag, injecting the electrolyte into the packaging bag, and sealing it to obtain a secondary battery. In addition, components such as overcurrent protection elements and guide plates can be placed in the packaging bag as needed to prevent pressure rise, overcharge, and overdischarge inside the secondary battery.

A fifth aspect of this application provides an electronic apparatus including the secondary battery according to any one of the foregoing embodiments. Therefore, the electronic apparatus provided in this application has a high initial Coulombic efficiency, low cycling capacity degradation, and high energy density.

This application does not specifically limit the type of electronic apparatus, and it may be any electronic apparatus known in the prior art. In some embodiments, the electronic apparatus may include, but is not limited to, a notebook computer, a pen-input computer, a mobile computer, an e-book player, a portable phone, a portable fax machine, a portable copier, a portable printer, a head-mounted stereo earphone, a video recorder, an LCD TV, a portable cleaner, a portable CD player, a mini disc, a transceiver, an electronic notebook, a calculator, a memory card, a portable recorder, a radio, a backup power supply, a motor, an automobile, a motorcycle, a power-assisted bicycle, a bicycle, a lighting fixture, a toy, a gaming console, a clock, an electric tool, a flashlight, a camera, a large household battery, a lithium-ion capacitor, and the like.

### EXAMPLES

The following describes the embodiments of this application more specifically by using examples and comparative examples. Various tests and evaluations are conducted according to the methods described below. Unless otherwise specified, “part” and “%” are based on mass.

### Test Methods and Equipment:

Tests on mass percentages of lithium element in the first region, second region, and third region:

A prelithiated negative electrode plate was taken, and along the thickness direction of the negative electrode plate, the negative electrode material substances from the top ⅓ thickness, middle ⅓ thickness, and bottom ⅓ thickness were scraped off using a blade, which were used as the negative electrode material substances for the first region, second region, and third region, respectively.

The mass percentages of lithium element in the negative electrode material substances of the first region, second region, and third region were determined using an inductively coupled plasma-optical emission spectrometer (ICP-OES). The ICP-OES used was a PE7000DV spectrometer manufactured by PerkinElmer, USA. The test conditions of the ICP-OES were set as follows: radio frequency (RF) at 40.68 MHz, RF power at 1300 W, argon secondary pressure at 0.6 MPa, auxiliary gas flow rate at 0.2 L/min, cooling gas flow rate at 15 L/min, and pump speed at 1.5 mL/min.

### Test on Mass Percentage of Silicon Element in the Negative Electrode Material Layer:

A prelithiated negative electrode plate was taken, and the negative electrode material substance on the surface of the negative electrode current collector was scraped off using a blade. The mass percentage of silicon element in the negative electrode material substance was determined using an inductively coupled plasma-optical emission spectrometer (ICP-OES). The ICP-OES used was a PE7000DV spectrometer manufactured by PerkinElmer, USA. The test conditions of the ICP-OES were set as follows: radio frequency (RF) at 40.68 MHz, RF power at 1300 W, argon secondary pressure at 0.6 MPa, auxiliary gas flow rate at 0.2 L/min, cooling gas flow rate at 15 L/min, and pump speed at 1.5 mL/min.

### Porosity Tests for First Region, Second Region, and Third Region:

(1) Test on total porosity of negative electrode material layer (S1+S2+S3):
(a) Sample preparation: A prelithiated negative electrode plate was taken, wrapped with weighing paper on both sides, placed flat on a die, and punched using a punching machine to obtain 40 circular samples with a diameter of 16 mm. The thickness of the circular samples was measured, and the average value h₁ was taken.
(b) Test: The 40 circular samples obtained in step (a) were placed into the sample cup of a true density instrument (model: AccuPyc II 1340), and the lid was tightened. The test was conducted three times, and the average of the test results was recorded as the true volume V2 of the circular samples. The test temperature was also recorded.
(c) Result analysis: Apparent volume V1=s× h₁× number of circular samples, where s is the surface area of the circular samples, and h₁ is the thickness of the circular samples. The porosity of the circular samples was calculated according to Porosity (Porosity)=(V1−V2)/V1×100%, that is, S1+S2+S3.
(2) Test on total porosity of second region and third region (S2+S3):
(a) Sample Preparation: The Circular Samples Tested in Step (1) were Taken, and the top ⅓ thickness of the negative electrode material substance was scraped off using a blade. The thickness of the circular samples was measured, and the average value h₁−1 was taken.
(b) Test: The 40 circular samples obtained in step (a) were placed into the sample cup of a true density instrument (model: AccuPyc II 1340), and the lid was tightened. The test was conducted three times, and the average of the test results was recorded as the true volume V2−1 of the circular samples. The test temperature was also recorded.
(c) Result analysis: Apparent volume V1−1=s×h₁−1×number of circular samples, where s is the surface area of the circular samples, and h₁−1 is the thickness of the circular samples. The porosity of the circular samples was calculated according to Porosity (Porosity)=(V1−1−V2−1)/V1−1×100%, that is, S2+S3.
(3) Porosity of third region (S3):
(a) Sample preparation: The circular samples tested in step (2) were taken, and another top ⅓ thickness of the negative electrode material substance was scraped off using a blade. The thickness of the circular samples was measured, and the average value h₁−2 was taken.
(b) Test: The 40 circular samples obtained in step (a) were placed into the sample cup of a true density instrument (model: AccuPyc II 1340), and the lid was tightened. The test was conducted three times, and the average of the test results was recorded as the true volume V2−2 of the circular samples. The test temperature was also recorded.
(c) Result analysis: Apparent volume V1−2=s×h₁−2×number of circular samples, where s is the surface area of the circular samples, and h₁−2 is the thickness of the circular samples. The porosity of the circular samples was calculated according to Porosity (Porosity)=(V1−2−V2−2)/V1−2×100%, that is, S3.
(4) Calculation of porosity of first region and porosity of second region:

$$Porosity of the first region S 1 ( \% ) = ( S 1 + S 2 + S 3 ) - ( S 2 + S 3 ) ;$$

$$Porosity of the second region S 2 ( \% ) = ( S 2 + S 3 ) - S 3.$$

Thickness tests for support layer, lithium supplementation layer, and interface layer:

The sample under test was placed on the platform and leveled. The thickness data was measured as required. The measuring end face of the micrometer gauge was wiped with a non-woven fabric. The measuring linkage mechanism was pressed to bring the two measuring end faces into full contact, and the “zero” button was pressed. The two measuring end faces of the micrometer gauge were brought into contact with the end face of the sample, and the displayed reading was recorded. Measurements were taken at intervals of 70 mm along the direction perpendicular to the tape running direction (that is, the TD direction), and measurements were taken at intervals of 100 mm along the tape running direction (that is, the MD direction). Twelve points were tested along the TD direction of the sample, and twelve points were tested along the MD direction of the sample, totaling 24 points. The average thickness of the 24 points was taken as the thickness of the sample under test.

When the support layer was used as the sample, the thickness H3 of the support layer was obtained.

When the composite of the support layer and the lithium supplementation layer was used as the sample, the total thickness Hₛᵤₚₚₒᵣₜ layer & lithium supplementation layer of the support layer and the lithium supplementation layer was obtained. The difference between the total thickness Hₛᵤₚₚₒᵣₜ layer & lithium supplementation layer of the support layer and the lithium supplementation layer and the thickness H3 of the support layer was the thickness H2 of the lithium supplementation layer, that is, H2=H_{support layer & lithium supplementation layer}−H3.

When the composite of the support layer, lithium supplementation layer, and interface layer was used as the sample, the total thickness H_{support layer & lithium supplementation layer & interface layer} of the support layer, lithium supplementation layer, and interface layer was obtained. The thickness of the interface layer was H1, and H1=H_{support layer & lithium supplementation layer & interface layer}−H_{support layer & lithium supplementation layer}.

### Coverage Ratio Test for Interface Particles on the Lithium Supplementation Layer:

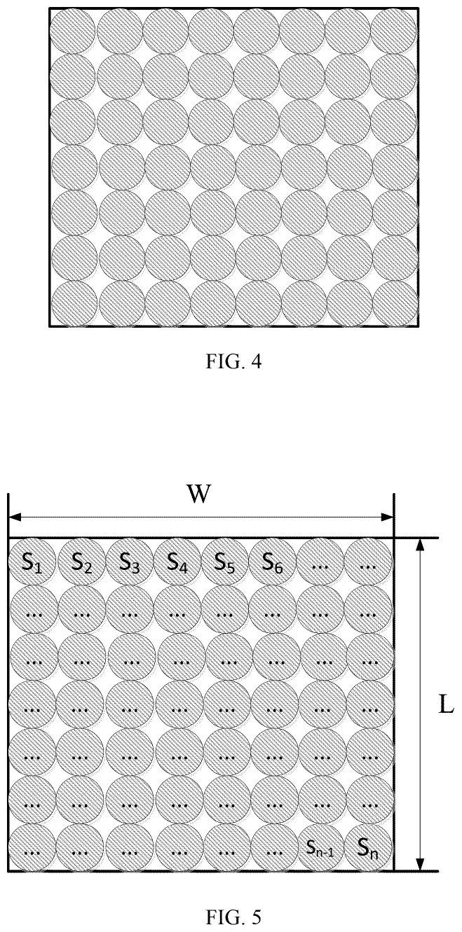

(1) The sample was placed flat on the sample stage, and then magnified photos of the sample were taken using an optical microscope (Keyence VHX-7000, 300× magnification).
(2) The photographed images were imported into the image processing software IMAGE J. The lithium supplementation region and the interface region were distinguished by threshold, and the area of each interface region, S₁ to Sₙ, was calculated. The total area of the interface region was calculated as S_{interface}=S₁+S₂+S₃+ . . . +Sₙ₋₁+Sₙ. The length L and width W of the lithium supplementation region were measured, and the total area of the lithium supplementation region was calculated: S_{lithium supplementation}=W×L. The coverage ratio of the interface particles on the lithium supplementation layer was calculated: s1=S_{interface}/S_{lithium supplementation}. See FIG. 4 and FIG. 5 for details.
(3) Twelve parallel samples were tested for each sample, and the average of the 12 s1 values was taken as the coverage ratio of the interface particles on the lithium supplementation layer.

### Test on Proportion of Depth of Interface Particles Embedded in Lithium Supplementation Layer to Thickness of Interface Layer:

(1) Sample preparation: The lithium supplementation composite layer sample was cut into 6 mm×6 mm dimensions and attached to the sample stage with conductive adhesive. The cross-section of the lithium supplementation composite layer sample was polished using a cross-section polisher (cross section polisher, model: IB-19520CCP) with the following polishing conditions: vacuum degree at 10⁻³ Pa, acceleration voltage at 6 kV, and grinding speed at 500 microns/hour.
(2) Parameter test: The polished sample was placed on the sample stage of a scanning electron microscope, and its cross-section was tested using the scanning electron microscope (SEM, scanning electron microscope, model: Thermo Fisher FEI-Apreo S) with the following test conditions: acceleration voltage at 10 kV, raster at 10 spots, working distance at 10 mm, and magnification at 2000×.

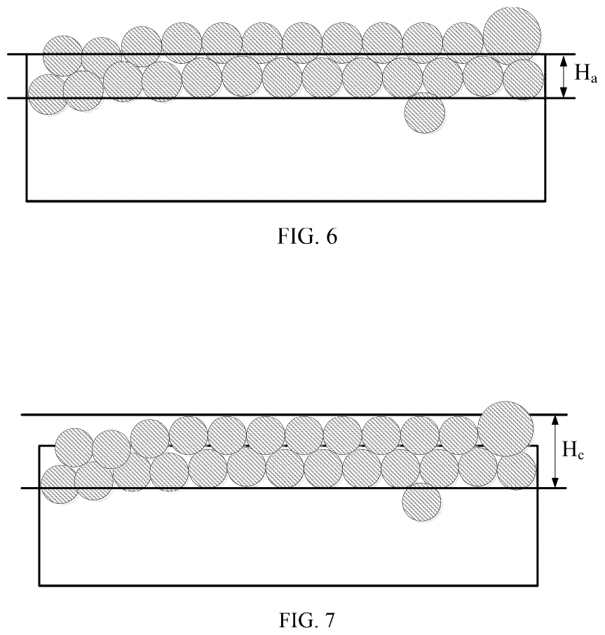

The depth Hₐ of the interface particles embedded in the lithium supplementation layer was defined as the height difference between the upper surface of the lithium supplementation layer and the lower surface of the interface layer, as shown in FIG. 6. He was defined as the height difference between the upper surface of the interface layer and the lower surface of the interface layer, as shown in FIG. 7. h=Hₐ/H_{c}. Twelve parallel samples were tested for each sample, and the average of the 12 h values was taken as the proportion of the depth of the interface particles embedded in the lithium supplementation layer to the thickness of the interface layer.

### Initial Coulombic Efficiency Test:

The voltage range was subject to that marked on the outer packaging of the factory-delivered battery. For example, when the factory-delivered battery was marked with a voltage range of 3.0 V to 4.45 V, the charging cutoff voltage was 4.45 V, and the discharging cutoff voltage was 3.0 V. The specific test steps were as follows: At 25° C., the lithium-ion battery of the examples or comparative examples was charged at a constant current of 0.2 C to the cutoff voltage of 4.45 V, then charged at a constant voltage of 4.45 V until the current was less than 0.05 C. After left standing for 5 minutes, the lithium-ion battery was discharged at a constant current of 0.2 C to the cutoff voltage of 3.0 V. The capacity in the charging process was recorded as C0, and the capacity in the discharging process was recorded as C1. The initial Coulombic efficiency was calculated using the following formula:

$$Initial Coulombic efficiency ( \% ) = C 1 / C 0 \times 100 \% .$$

### Cycling Performance Test:

The voltage range was subject to that marked on the outer packaging of the factory-delivered battery. For example, when the factory-delivered battery was marked with a voltage range of 3.0 V to 4.45 V, the charging cutoff voltage was 4.45 V, and the discharging cutoff voltage was 3.0 V. The specific test steps were as follows: At 25° C., the lithium-ion battery of the examples or comparative examples was subjected to its first charge and discharge cycle. The lithium-ion battery was charged at a constant current of 0.2 C to the cutoff voltage of 4.45 V, then charged at a constant voltage of 4.45 V until the current was less than 0.05 C. After left standing for 5 minutes, the lithium-ion battery was discharged at a constant current of 0.2 C to the cutoff voltage of 3.0 V, and the discharge capacity of the lithium-ion battery was measured as A. Subsequently, in a 25° C. environment, 400 charge and discharge cycles were performed according to the above steps, and the discharge capacity of the lithium-ion battery at the 400th cycle was measured as B. The cycling capacity retention rate was calculated using the following formula:

$$Cycling capacity retention rate ( \% ) = B / A \times 100 \% .$$

A larger value of the measured cycling capacity retention rate indicates a better cycling performance of the lithium-ion battery.

### Energy Density Test:

The voltage range was subject to that marked on the outer packaging of the factory-delivered battery. For example, when the factory-delivered battery was marked with a voltage range of 3.0 V to 4.45 V, the charging cutoff voltage was 4.45 V, and the discharging cutoff voltage was 3.0 V. The specific test steps were as follows: At 25° C., the lithium-ion battery of the examples or comparative examples was charged at a constant current of 0.2 C to the cutoff voltage of 4.45 V, then charged at a constant voltage of 4.45 V until the current was less than 0.05 C. After left standing for 5 minutes, the lithium-ion battery was discharged at a constant current of 0.2 C to the cutoff voltage of 3.0 V, and then left standing for 5 minutes. The energy in the discharge process was recorded as the discharge energy E. The volume V (mm³) of the lithium-ion battery was calculated as length×width×height.

$$Energy density ( Wh / L ) = E / V \times 1 {0}^{6} .$$

### Example 1-1

### <Preparation of Lithium Supplementation Composite Layer>

Under an ambient temperature of 25° C. and a humidity of 1.0%, the lithium foil was rolled onto a copper foil support layer with a thickness of 14 μm to form a lithium supplementation layer, subjected to a rolling pressure P12 of 1.5 T/10 mm, to obtain a lithium supplementation layer/support layer composite structure.

Under an ambient temperature of 25° C. and a humidity of 1.0%, interface particles of artificial graphite were applied onto the surface of the lithium supplementation layer by wiping to form an interface layer, followed by rolling with a rolling pressure P2 of 0.5 T/10 mm, a rolling temperature T1 of 90° C., and a rolling rest time t1 of 30 minutes, to form a lithium supplementation composite layer. In the lithium supplementation composite layer, the thickness H1 of the interface layer was 8 μm, the thickness H2 of the lithium supplementation layer was 0.03 mm, the coverage ratio s1 of the interface particles on the lithium supplementation layer was 85%, and the depth of the interface particles embedded in the lithium supplementation layer accounted for 50% of the thickness of the interface layer.

### <Preparation of Negative Electrode Plate>

The silicon-carbon material as the negative electrode active material, acetylene black as the negative electrode conductive agent, styrene-butadiene rubber (SBR) as the negative electrode binder, and lithium carboxymethyl cellulose as the negative electrode binder were mixed at a weight ratio of 85:5:5:5. Deionized water was added as a solvent, and the mixture was stirred to obtain a uniform negative electrode slurry with a solid content of 28 wt %. The negative electrode slurry was evenly applied onto one surface of a negative electrode current collector copper foil with a thickness of 12 μm, followed by drying at 90° C., to obtain a negative electrode plate coated with the negative electrode material layer on one side. The same steps were repeated on the other surface of the copper foil, to obtain a negative electrode plate coated with the negative electrode material layers on two sides. The negative electrode plate was dried under vacuum at 90° C. for 1 hour, followed by cold pressing, cutting, and slitting, to obtain a negative electrode plate with dimensions of 51 mm×44.2 mm. The silicon-carbon material was a silicon-carbon composite material, and based on the mass of the silicon-carbon composite material, a mass percentage w_{Si} of silicon element was 50% and a mass percentage w^{C} of carbon element was 50%. The areal density CW of the negative electrode material layer was 2.3 mg/cm², and the compaction density in the cold pressing process was 1.0 g/cm³.

### <Preparation of Prelithiated Negative Electrode Plate>

The prepared negative electrode plate was dried until the water content was less than or equal to 500 ppm. Under conditions of ambient temperature of 90° C. and humidity of 1.0%, the prepared lithium supplementation composite layer was laminated with the prepared negative electrode plate to bring the interface layer into contact with the negative electrode material layer, where the lamination method was pressing into a sheet. Prelithiation treatment was performed with an interface pressure P3 of 0.6 MPa between the interface layer and the negative electrode material layer, a lamination time t2 of 20 h between the interface layer and the negative electrode material layer, and a lamination temperature T2 of 90° C. between the interface layer and the negative electrode material layer. After the prelithiation treatment ended, the lithium supplementation composite layer was peeled off from the negative electrode plate, to form a prelithiated negative electrode plate. Based on the mass of the first region, the mass percentage W1 of lithium element was 16.5%; based on the mass of the second region, the mass percentage W2 of lithium element was 10.5%; based on the mass of the third region, the mass percentage W3 of lithium element was 6.5%, where W1>W2>W3.

### <Preparation of Positive Electrode Plate>

The lithium cobalt oxide (LiCoO₂) as the positive electrode active material, acetylene black as the positive electrode conductive agent, and polyvinylidene fluoride (PVDF) as the positive electrode binder were mixed at a weight ratio of 97:1.4:1.6, and N-methylpyrrolidone (NMP) was added as a solvent. The mixture was stirred to uniformity to obtain the positive electrode slurry, where the solid content of the positive electrode slurry was 75 wt %. The positive electrode slurry was evenly applied onto one surface of a positive electrode current collector aluminum foil with a thickness of 12 μm, followed by drying at 110° C. to obtain a positive electrode plate coated with the positive electrode material layer on one side. The same steps were repeated on the other surface of the aluminum foil to obtain a positive electrode plate coated with the positive electrode material layers on two sides. The positive electrode plate was dried under vacuum at 110° C. for 1 hour, followed by cold pressing, cutting, and slitting, to obtain a positive electrode plate with specifications of 48 mm×41.2 mm. The areal density of the positive electrode material layer was 19.0 mg/cm², and the compaction density in the cold pressing process was 4.15 g/cm³.

### <Preparation of Electrolyte>

In an argon atmosphere glove box with a water content of less than 10 ppm, ethylene carbonate (EC), propylene carbonate (PC), diethyl carbonate (DEC), and ethyl propionate (EP) were mixed at a weight ratio of 3:1:3:3 to obtain a base solvent. The lithium salt lithium hexafluorophosphate (LiPF₆) was added and mixed to uniformity to obtain the electrolyte. Based on the mass of the electrolyte, the mass percentage of the lithium salt LiPF₆ was 12.5%, with the remainder being the base solvent.

### <Preparation of Separator>

A porous polypropylene film with a thickness of 5 μm (provided by Celgard) was used as the separator.

### <Preparation of Lithium-Ion Battery>

The prepared positive electrode plate, separator, prelithiated negative electrode plate, and separator were stacked in order, with the separator placed between the positive electrode plate and the prelithiated negative electrode plate to provide separation. The stack was wound to obtain an electrode assembly. After the tabs were welded, the electrode assembly was placed in an aluminum-plastic film packaging bag which was dried in a vacuum oven at 85° C. for 12 hours to remove moisture. The electrolyte was injected, and vacuum sealing, resting, formation (charged at a constant current of 0.02 C to 3.5 V, and then charged at a constant current of 0.1 C to 3.9 V), degassing, trimming, and capacity processing steps were performed to obtain a lithium-ion battery.

### Examples 1-2 to 1-5

The steps were the same as in Example 1-1, except that the relevant preparation parameters were adjusted according to Table 1. The sum of the mass percentages of the negative electrode active material, negative electrode conductive agent acetylene black, negative electrode binder styrene-butadiene rubber, and negative electrode binder lithium carboxymethyl cellulose was 100%, and the mass ratio of the negative electrode conductive agent acetylene black, negative electrode binder styrene-butadiene rubber, and negative electrode binder lithium carboxymethyl cellulose remained unchanged.

### Example 1-6

The steps were the same as in Example 1-1, except for the following details in the <Preparation of negative electrode plate>: the negative electrode active material was a mixture of the silicon-containing substance silicon-carbon material and the carbon material artificial graphite, and based on the mass of the negative electrode active material, the mass percentage W_{Si} of the silicon-containing substance was 5%, and the mass percentage Wc of the carbon material was 95%; and the silicon-carbon material was a silicon-carbon composite material, and based on the mass of the silicon-carbon composite material, the mass percentage w_{Si} of silicon element was 30%, and the mass percentage w^{C} of carbon element was 70%. The sum of the mass percentages of the negative electrode active material, negative electrode conductive agent acetylene black, negative electrode binder styrene-butadiene rubber, and negative electrode binder lithium carboxymethyl cellulose was 100%, and the mass ratio of the negative electrode conductive agent acetylene black, negative electrode binder styrene-butadiene rubber, and negative electrode binder lithium carboxymethyl cellulose remained unchanged.

### Examples 1-7 to 1-11

The steps were the same as in Example 1-6, except that the relevant preparation parameters were adjusted according to Table 1. The sum of the mass percentages of the negative electrode active material, negative electrode conductive agent acetylene black, negative electrode binder styrene-butadiene rubber, and negative electrode binder lithium carboxymethyl cellulose was 100%, and the mass ratio of the negative electrode conductive agent acetylene black, negative electrode binder styrene-butadiene rubber, and negative electrode binder lithium carboxymethyl cellulose remained unchanged.

### Example 1-12

The steps were the same as in Example 1-1, except that the relevant preparation parameters were adjusted according to Table 1.

### Example 1-13

The steps were the same as in Example 1-10, except that the relevant preparation parameters were adjusted according to Table 1.

### Examples 2-1 to 2-11

The steps were the same as in Example 1-1, except that the relevant preparation parameters were adjusted according to Table 3.

### Example 2-12

The steps were the same as in Example 1-1, except that the relevant preparation parameters were adjusted according to Table 3 and the thickness H1 of the interface layer in the lithium supplementation composite layer was 2 μm.

### Examples 2-13 to 2-14

The steps were the same as in Example 1-1, except that the relevant preparation parameters were adjusted according to Table 3.

### Comparative Example 1-1

The steps were the same as in Example 1-1, except that in <Preparation of lithium supplementation composite layer>, no interface layer was provided.

### Comparative Examples 2-1 to 2-5

The steps were the same as in Example 1-1, except that the relevant preparation parameters were adjusted according to Table 3.

The preparation parameters and electrical performance parameters of each example and comparative example are shown in Tables 1 to 3.

TABLE 1

| | | Mass | | | | | | | | | | | | | | | | |
|---|---|---|---|---|---|---|---|---|---|---|---|---|---|---|---|---|---|---|
| | | percentage | | | | | | | | | | | | | | | | |
| | | of negative | | | | | | | | | | | | | | | | |
| | | electrode | | | | | | | | | | | | | | | | |
| | | active | | | | | | | | | | | | | | | | |
| | | material in | | | | | | | | | | | | | | | | |
| | | negative | | | | | | | | | | | | | | | | |
| | Silicon- | electrode | | | | | | | | | | | | | | | | |
| | containing | material | Wsi | wsi | wc | Carbon | Wc | w1 | W1 | W2 | W3 | W1/ | W2/ | S1 | S2 | S3 | S1/ | S2/ |
| | substance | layer (%) | (%) | (%) | (%) | material | (%) | (%) | (%) | (%) | (%) | W2 | W3 | (%) | (%) | (%) | S2 | S3 |
| Example | Silicon- | 85 | 100 | 50 | 50 | / | 0 | 40 | 16.5 | 10.5 | 6.5 | 1.57 | 1.62 | 49.5 | 40.0 | 32.0 | 1.24 | 1.25 |
| 1-1 | carbon | | | | | | | | | | | | | | | | | |
| | material | | | | | | | | | | | | | | | | | |
| Example | Silicon- | 75 | 100 | 30 | 70 | / | 0 | 18.6 | 10.8 | 9.2 | 4.6 | 1.17 | 2.00 | 42.1 | 38.0 | 25.3 | 1.11 | 1.50 |
| 1-2 | carbon | | | | | | | | | | | | | | | | | |
| | material | | | | | | | | | | | | | | | | | |
| Example | Silicon- | 98.5 | 100 | 70 | 30 | / | 0 | 63.5 | 18.4 | 11.4 | 9.1 | 1.61 | 1.25 | 57.0 | 42.0 | 37.9 | 1.36 | 1.11 |
| 1-3 | carbon | | | | | | | | | | | | | | | | | |
| | material | | | | | | | | | | | | | | | | | |
| Example | Silicon- | 85 | 100 | 30 | 70 | / | 0 | 25 | 11.5 | 11.4 | 6.3 | 1.01 | 1.81 | 42.3 | 42 | 31 | 1.01 | 1.35 |
| 1-4 | carbon | | | | | | | | | | | | | | | | | |
| | material | | | | | | | | | | | | | | | | | |
| Example | Silicon- | 85 | 100 | 70 | 30 | / | 0 | 50 | 18.4 | 9.2 | 9.1 | 2.00 | 1.01 | 57.0 | 38.0 | 37.8 | 1.50 | 1.01 |
| 1-5 | carbon | | | | | | | | | | | | | | | | | |
| | material | | | | | | | | | | | | | | | | | |
| Example | Silicon- | 75 | 5 | 30 | 70 | Artificial | 95 | 1.1 | 0.38 | 0.3 | 0.15 | 1.27 | 2.00 | 26.3 | 23.7 | 15.8 | 1.11 | 1.50 |
| 1-6 | carbon | | | | | graphite | | | | | | | | | | | | |
| | material | | | | | | | | | | | | | | | | | |
| Example | Silicon- | 85 | 5 | 50 | 50 | Artificial | 95 | 2.1 | 0.5 | 0.34 | 0.22 | 1.47 | 1.55 | 30.5 | 25.0 | 20.0 | 1.22 | 1.25 |
| 1-7 | carbon | | | | | graphite | | | | | | | | | | | | |
| | material | | | | | | | | | | | | | | | | | |
| Example | Silicon- | 98.5 | 5 | 70 | 30 | Artificial | 95 | 3.4 | 0.6 | 0.37 | 0.29 | 1.62 | 1.28 | 35.5 | 26.2 | 23.6 | 1.35 | 1.11 |
| 1-8 | carbon | | | | | graphite | | | | | | | | | | | | |
| | material | | | | | | | | | | | | | | | | | |
| Example | Silicon- | 75 | 15 | 30 | 70 | Artificial | 85 | 3.3 | 2.8 | 2.2 | 1.1 | 1.27 | 2.00 | 31.6 | 28.4 | 18.9 | 1.11 | 1.50 |
| 1-9 | carbon | | | | | graphite | | | | | | | | | | | | |
| | material | | | | | | | | | | | | | | | | | |
| Example | Silicon- | 85 | 15 | 50 | 50 | Artificial | 85 | 6.2 | 3.5 | 2.5 | 1.6 | 1.40 | 1.56 | 37.0 | 30 | 24 | 1.23 | 1.25 |
| 1-10 | carbon | | | | | graphite | | | | | | | | | | | | |
| | material | | | | | | | | | | | | | | | | | |
| Example | Silicon- | 98.5 | 15 | 70 | 30 | Artificial | 85 | 10.2 | 4.5 | 2.7 | 2.1 | 1.67 | 1.29 | 42.6 | 31.5 | 28.3 | 1.35 | 1.11 |
| 1-11 | carbon | | | | | graphite | | | | | | | | | | | | |
| | material | | | | | | | | | | | | | | | | | |
| Example | SiO | 85 | 100 | / | / | / | 0 | 50 | 11.5 | 10.5 | 6.5 | 1.10 | 1.62 | 42.1 | 40.1 | 32 | 1.05 | 1.25 |
| 1-12 | | | | | | | | | | | | | | | | | | |
| Example | Silicon- | 85 | 15 | 50 | 50 | Hard | 85 | 6.2 | 3.7 | 2.6 | 1.65 | 1.42 | 1.58 | 38 | 31 | 25 | 1.23 | 1.24 |
| 1-13 | carbon | | | | | carbon | | | | | | | | | | | | |
| | material | | | | | | | | | | | | | | | | | |
| Comparative | Silicon- | 85 | 100 | 50 | 50 | / | 0 | 18.5 | 30 | 6 | 2 | 5.00 | 3.00 | 60 | 35 | 20 | 1.71 | 1.75 |
| Example | carbon | | | | | | | | | | | | | | | | | |
| 1-1 | material | | | | | | | | | | | | | | | | | |

Note:
In Table 1, “/” indicates no relevant preparation parameters.

TABLE 2

| | Initial Coulombic | Cycling capacity | Energy density |
|---|---|---|---|
| | efficiency (%) | retention rate (%) | (Wh/L) |
| Example 1-1 | 92.5 | 90.5 | 854.4 |
| Example 1-2 | 91.0 | 85.0 | 825.0 |
| Example 1-3 | 92.9 | 84.0 | 840.0 |
| Example 1-4 | 92.0 | 91.0 | 830.0 |
| Example 1-5 | 92.7 | 85.0 | 860.0 |
| Example 1-6 | 92.5 | 87.0 | 753.0 |
| Example 1-7 | 93.5 | 92.5 | 784.4 |
| Example 1-8 | 94.0 | 86.0 | 770.0 |
| Example 1-9 | 92.0 | 86.0 | 785.0 |
| Example 1-10 | 93.0 | 91.5 | 804.3 |
| Example 1-11 | 93.4 | 87.0 | 795.0 |
| Example 1-12 | 90.8 | 87.9 | 823.1 |
| Example 1-13 | 92.0 | 92.5 | 800.0 |
| Comparative | 78.2 | 76.5 | 722.5 |
| Example 1-1 | | | |

From Examples 1-1 to 1-13 and Comparative Example 1-1, it can be seen that when the preparation method of lithium supplementation composite layer provided in this application is used to prepare the lithium supplementation composite layer, and then the lithium supplementation method provided in this application is used to prepare the prelithiated negative electrode plate, the use of the resulting prelithiated negative electrode plate in a lithium-ion battery allows the prepared lithium-ion battery to have high initial Coulombic efficiency, cycling capacity retention rate, and energy density. This indicates that the solution in this application can improve the initial Coulombic efficiency of the lithium-ion battery, reduce cycling capacity degradation, and enhance the energy density of the lithium-ion battery. In Comparative Example 1-1, the preparation method of lithium supplementation composite layer is not within the scope of this application, and the prepared lithium-ion battery has relatively low initial Coulombic efficiency, cycling capacity retention rate, and energy density.

From Examples 1-1 to 1-3, it can be seen that when the negative electrode active material includes only the silicon-containing substance, as the mass percentage of the negative electrode active material in the negative electrode material layer increases, and the mass percentage of silicon element in the silicon-carbon material increases, the mass percentage of silicon element in the negative electrode material layer increases, and the porosity of the first region, second region, and third region increases, improving the kinetic performance of the prelithiated negative electrode plate, and facilitating the transmission of lithium ions from top to bottom during lithium supplementation.

From Examples 1-1, 1-4, and 1-5, it can be seen that when the mass percentage of the negative electrode active material in the negative electrode material layer remains unchanged, an increase in the mass percentage of silicon element in the silicon-carbon material is more conducive to lithium supplementation in the surface layer.

The values of W1/W2 and W2/W3 typically affect the initial Coulombic efficiency, cycling capacity retention rate, and energy density of the lithium-ion battery. From Examples 1-1 to 1-13, it can be seen that when the values of W1/W2 and W2/W3 are within the scopes of this application, the prepared lithium-ion battery has high initial Coulombic efficiency, cycling capacity retention rate, and energy density. This indicates that the solution in this application can improve the initial Coulombic efficiency of the lithium-ion battery, reduce cycling capacity degradation, and enhance the energy density of the lithium-ion battery.

The type of the negative electrode active material typically affects the initial Coulombic efficiency, cycling capacity retention rate, and energy density of the lithium-ion battery. From Examples 1-1, 1-7, and 1-10, or Examples 1-2, 1-6, and 1-9, or Examples 1-3, 1-8, and 1-11, it can be seen that when the type of the negative electrode active material is within the scope of this application, the prepared lithium-ion battery has high initial Coulombic efficiency, cycling capacity retention rate, and energy density. This indicates that the solution in this application can improve the initial Coulombic efficiency of the lithium-ion battery, reduce cycling capacity degradation, and enhance the energy density of the lithium-ion battery.

The values of S1/S2 and S2/S3 typically affect the initial Coulombic efficiency, cycling capacity retention rate, and energy density of the lithium-ion battery. From Examples 1-1 to 1-13, it can be seen that when the values of S1/S2 and S2/S3 are within the scopes of this application, the prepared lithium-ion battery has high initial Coulombic efficiency, cycling capacity retention rate, and energy density. This indicates that the solution in this application can improve the initial Coulombic efficiency of the lithium-ion battery, reduce cycling capacity degradation, and enhance the energy density of the lithium-ion battery.

TABLE 3

| | | | | | | Initial | Cycling | |
|---|---|---|---|---|---|---|---|---|
| | P2 | | | | Type of lithium | Coulombic | capacity | Energy |
| | (T/10 | T1 | t1 | Type of interface | supplementation | efficiency | retention rate | density |
| | mm) | (° C.) | (min) | particles | layer | (%) | (%) | (Wh/L) |
| Example 1-1 | 0.5 | 90 | 30 | Artificial graphite | Lithium foil | 92.5 | 90.5 | 854.4 |
| Example 2-1 | 0.1 | 90 | 30 | Artificial graphite | Lithium foil | 88.00 | 86.00 | 800 |
| Example 2-2 | 0.2 | 90 | 30 | Artificial graphite | Lithium foil | 89 | 87 | 815 |
| Example 2-3 | 0.8 | 90 | 30 | Artificial graphite | Lithium foil | 92.70 | 88 | 856 |
| Example 2-4 | 2 | 90 | 30 | Artificial graphite | Lithium foil | 93.00 | 84 | 860 |
| Example 2-5 | 0.5 | 25 | 30 | Artificial graphite | Lithium foil | 87.5 | 85.50 | 795 |
| Example 2-6 | 0.5 | 50 | 30 | Artificial graphite | Lithium foil | 88.50 | 86.50 | 810 |
| Example 2-7 | 0.5 | 120 | 30 | Artificial graphite | Lithium foil | 92.80 | 87.70 | 857 |
| Example 2-8 | 0.5 | 170 | 30 | Artificial graphite | Lithium foil | 93.00 | 83 | 862 |
| Example 2-9 | 0.5 | 90 | 5 | Artificial graphite | Lithium foil | 88.50 | 86.70 | 812 |
| Example 2- | 0.5 | 90 | 10 | Artificial graphite | Lithium foil | 90.00 | 88 | 830 |
| 10 | | | | | | | | |
| Example 2- | 0.5 | 90 | 50 | Artificial graphite | Lithium foil | 92.80 | 87.80 | 858 |
| 11 | | | | | | | | |
| Example 2- | 0.5 | 90 | 30 | Single-walled carbon | Lithium foil | 85.5 | 83.0 | 786 |
| 12 | | | | nanotubes | | | | |
| Example 2- | 0.5 | 90 | 30 | 97% artificial graphite + | Lithium foil | 91.80 | 88.50 | 845 |
| 13 | | | | 3% single-walled carbon | | | | |
| | | | | nanotubes | | | | |
| Example 2- | 0.5 | 90 | 30 | Artificial graphite | Lithium- | 90.80 | 89.70 | 850 |
| 14 | | | | | aluminum alloy | | | |
| Comparative | 0.05 | 15 | 3 | Artificial graphite | Lithium foil | 82.00 | 80.00 | 740 |
| Example 2-1 | | | | | | | | |
| Comparative | 3 | 190 | 70 | Artificial graphite | Lithium foil | 81.00 | 79 | 770 |
| Example 2-2 | | | | | | | | |
| Comparative | 0.05 | 15 | 30 | Artificial graphite | Lithium foil | 82.50 | 81 | 750 |
| Example 2-3 | | | | | | | | |
| Comparative | 0.05 | 90 | 3 | Artificial graphite | Lithium foil | 83.00 | 82 | 760 |
| Example 2-4 | | | | | | | | |
| Comparative | 0.5 | 15 | 3 | Artificial graphite | Lithium foil | 82.30 | 81.50 | 755 |
| Example 2-5 | | | | | | | | |

Note:
(1) In Table 3, in Example 2-13, the “Type of interface particles” is “97% artificial graphite + 3% single-walled carbon nanotubes,” indicating that the interface particles include artificial graphite and single-walled carbon nanotubes, where based on the mass of the interface particles, the mass percentage of artificial graphite is 97%, and the mass percentage of single-walled carbon nanotubes is 3%.

From Examples 2-1 to 2-14 and Comparative Examples 2-1 to 2-5, it can be seen that when the preparation method of lithium supplementation composite layer provided in this application is used to prepare the lithium supplementation composite layer, and then the lithium supplementation method provided in this application is used to prepare the prelithiated negative electrode plate, the use of the resulting prelithiated negative electrode plate in a lithium-ion battery allows the prepared lithium-ion battery to have high initial Coulombic efficiency, cycling capacity retention rate, and energy density. This indicates that the solution in this application can improve the initial Coulombic efficiency of the lithium-ion battery, reduce cycling capacity degradation, and enhance the energy density of the lithium-ion battery. In Comparative Examples 2-1 to 2-5, the preparation method of lithium supplementation composite layer is not within the scope of this application, and the prepared lithium-ion battery has relatively low initial Coulombic efficiency, cycling capacity retention rate, and energy density.

From Examples 1-1 and 2-1 to 2-4, it can be seen that as the rolling pressure P2 increases, the lithium supplementation amount increases, the initial Coulombic efficiency of the lithium-ion battery increases, the energy density increases, and the cycling capacity retention rate first increases and then decreases, indicating that excessive lithium supplementation affects the cycling performance of the lithium-ion battery to some extent.

The type of the interface particles typically affects the initial Coulombic efficiency, cycling capacity retention rate, and energy density of the lithium-ion battery. From Examples 1-1, 2-12, and 2-13, it can be seen that when the type of the interface particles is within the scope of this application, the prepared lithium-ion battery has high initial Coulombic efficiency, cycling capacity retention rate, and energy density. This indicates that the solution in this application can improve the initial Coulombic efficiency of the lithium-ion battery, reduce cycling capacity degradation, and enhance the energy density of the lithium-ion battery. In Example 2-12, when the type of the interface particles is single-walled carbon nanotube, the thickness of the interface layer is affected by the diameter of the single-walled carbon nanotubes, resulting in a thinner interface layer. After lithium supplementation, more by-products remain in the negative electrode material layer, affecting the initial Coulombic efficiency, cycling capacity retention rate, and energy density of the lithium-ion battery.

The type of the lithium supplementation layer typically affects the initial Coulombic efficiency, cycling capacity retention rate, and energy density of the lithium-ion battery. From Examples 1-1 and 2-14, it can be seen that when the type of the lithium supplementation layer is within the scope of this application, the prepared lithium-ion battery has high initial Coulombic efficiency, cycling capacity retention rate, and energy density. This indicates that the solution in this application can improve the initial Coulombic efficiency of the lithium-ion battery, reduce cycling capacity degradation, and enhance the energy density of the lithium-ion battery.

It should be noted that in this specification, relational terms such as first and second are used solely to distinguish one entity or operation from another entity or operation, but do not necessarily require or imply any actual relationship or order between such entities or operations. Moreover, the terms “include,” “comprise,” or any other variants are intended to cover a non-exclusive inclusion, such that a process, method, or article that includes a list of elements not only includes those elements but also includes other elements that are not expressly listed, or further includes elements inherent to such process, method, or article.

The embodiments in this specification are described in an interrelated manner. For a part that is the same or similar between different embodiments, reference may be made between the embodiments. Each embodiment focuses on the differences from other embodiments.

The foregoing descriptions are merely preferred embodiments of this application, but are not intended to limit this application. Any modification, equivalent replacement, or improvement made without departing from the spirit and principle of this application shall fall within the protection scope of this application.

What is claimed is:

1. A preparation method of lithium supplementation composite layer, comprising the following steps:
(1) applying a lithium metal powder slurry onto a support layer, followed by drying and rolling, to form a lithium supplementation layer; or rolling lithium foil and/or lithium alloy foil onto a support layer to form a lithium supplementation layer; or applying a molten lithium or lithium alloy slurry onto a support layer, followed by cooling and rolling, to form a lithium supplementation layer; wherein a rolling pressure P1 is 0.1 T/10 mm to 2 T/10 mm; and
(2) applying interface particles onto a surface of the lithium supplementation layer to form an interface layer, followed by rolling, to form a lithium supplementation composite layer, wherein a rolling pressure P2 is 0.1 T/10 mm to 2 T/10 mm, a rolling temperature T1 is 25° C. to 170° C., and a rolling rest time t1 is 5 min to 50 min.

2. The preparation method according to claim 1, wherein the lithium supplementation composite layer comprises the support layer, the lithium supplementation layer, and the interface layer; wherein the lithium supplementation layer is disposed between the support layer and the interface layer, the interface layer comprises the interface particles, and the lithium supplementation layer comprises at least one of lithium foil or lithium alloy foil.

3. The preparation method according to claim 1, wherein the interface particles comprise at least one of a conductive agent or a lithiation material; the conductive agent comprises at least one of conductive carbon black, carbon fiber, graphene, or carbon nanotubes; and the lithiation material comprises at least one of artificial graphite, natural graphite, hard carbon, silicon-carbon material, or silicon-oxygen material.

4. A lithium supplementation method, comprising the following steps:
drying a negative electrode plate, wherein the negative electrode plate comprises a negative electrode current collector and a negative electrode material layer disposed on at least one surface of the negative electrode current collector; and
laminating the lithium supplementation composite layer prepared using the preparation method according to claim 1 with the negative electrode plate to bring the interface layer into contact with the negative electrode material layer, performing prelithiation treatment, wherein an interface pressure P3 between the interface layer and the negative electrode material layer is 0.1 MPa to 2 MPa, a lamination time t2 between the interface layer and the negative electrode material layer is 0.5 h to 72 h, and a lamination temperature T2 between the interface layer and the negative electrode material layer is 50° C. to 180° C., and after the prelithiation treatment ends, peeling off the lithium supplementation composite layer from the negative electrode plate to form a prelithiated negative electrode plate.

5. A secondary battery, comprising the prelithiated negative electrode plate prepared using the lithium supplementation method according to claim 4, wherein the negative electrode plate comprises a negative electrode current collector and a negative electrode material layer; wherein along a thickness direction of the negative electrode plate, the negative electrode material layer comprises a first surface and a second surface opposite to each other;
from the first surface to the second surface, the negative electrode material layer sequentially comprises a first region, a second region, and a third region; the third region being located on a surface of the negative electrode current collector;
a thickness of the first region accounts for ⅓ of a thickness of the negative electrode material layer, a thickness of the second region accounts for ⅓ of the thickness of the negative electrode material layer, and a thickness of the third region accounts for ⅓ of the thickness of the negative electrode material layer; and
based on a mass of the first region, a mass percentage of lithium element in the first region is W1; based on a mass of the second region, a mass percentage of lithium element in the second region is W2; and based on a mass of the third region, a mass percentage of lithium element in the third region is W3, wherein W1>W2>W3, 1.01≤W1/W2≤2.0, and 1.01≤W2/W3≤2.0.

6. The secondary battery according to claim 5, wherein the negative electrode material layer comprises a negative electrode active material, wherein the negative electrode active material comprises at least one of a carbon material or a silicon-containing substance, the carbon material comprises at least one of a graphite material or hard carbon, and the silicon-containing substance comprises at least one of a silicon-carbon material or a silicon-oxygen material.

7. The secondary battery according to claim 6, wherein the negative electrode active material comprises only the silicon-containing substance; and based on a mass of the negative electrode material layer, a mass percentage of silicon element in the negative electrode material layer is w1, wherein 18.6%≤w1≤63.5%, 11.5%≤W1≤18.4%, 9.2%≤W2<11.5%, and 4.6%≤W3<9.2%.

8. The secondary battery according to claim 6, wherein the negative electrode active material comprises the carbon material and the silicon-containing substance; and based on a mass of the negative electrode material layer, a mass percentage of silicon element in the negative electrode material layer is w1, wherein 1.1%≤w1≤3.4%, 0.38%≤W1≤0.60%, 0.30%≤W2<0.38%, and 0.15%≤W3<0.30%.

9. The secondary battery according to claim 6, wherein the negative electrode active material comprises the carbon material and the silicon-containing substance; and based on a mass of the negative electrode material layer, a mass percentage of silicon element in the negative electrode material layer is w1, wherein 3.3%≤w1≤10.2%, 2.8%≤W1≤4.5%, 2.2%≤W2<2.8%, and 1.1%≤W3<2.2%.

10. The secondary battery according to claim 6, wherein a porosity of the first region is S1, a porosity of the second region is S2, and a porosity of the third region is S3, wherein S1>S2>S3.

11. The secondary battery according to claim 10, wherein 1.01≤S1/S2≤1.5, and 1.01≤S2/S3≤1.5.

12. The secondary battery according to claim 10, wherein the negative electrode active material comprises only the silicon-containing substance; and based on a mass of the negative electrode material layer, a mass percentage of silicon element in the negative electrode material layer is w1, wherein 18.6%≤w1≤63.5%, 42.1%≤S1≤57.0%, 38.0%≤S2<42.1%, and 25.0%≤S3<38.0%.

13. The secondary battery according to claim 10, wherein the negative electrode active material comprises the carbon material and the silicon-containing substance; and based on a mass of the negative electrode material layer, a mass percentage of silicon element in the negative electrode material layer is w1, wherein 1.1%≤w1≤3.4%, 26.3%≤S1≤35.5%, 23.7%≤S2<26.3%, and 15.8%≤S3<23.7%.

14. The secondary battery according to claim 10, wherein the negative electrode active material comprises the carbon material and the silicon-containing substance; and based on a mass of the negative electrode material layer, a mass percentage of silicon element in the negative electrode material layer is w1, wherein 3.3%≤w1≤10.2%, 31.6%≤S1≤42.6%, 28.4%≤S2<31.6%, and 18.9%≤S3<28.4%.

15. The secondary battery according to claim 6, wherein a porosity of the first region is S1, a porosity of the second region is S2, and a porosity of the third region is S3, wherein 1.01≤S1/S2≤1.5, and 1.01≤S2/S3≤1.5.

16. The secondary battery according to claim 6, wherein the negative electrode active material comprises only the silicon-containing substance; and based on a mass of the negative electrode material layer, a mass percentage of silicon element in the negative electrode material layer is w1, a porosity of the first region is S1, a porosity of the second region is S2, and a porosity of the third region is S3, wherein 18.6%≤w1≤63.5%, 42.1%≤S1≤57.0%, 38.0%≤S2<42.1%, and 25.0%≤S3<38.0%.

17. The secondary battery according to claim 6, wherein the negative electrode active material comprises the carbon material and the silicon-containing substance; and based on a mass of the negative electrode material layer, a mass percentage of silicon element in the negative electrode material layer is w1, a porosity of the first region is S1, a porosity of the second region is S2, and a porosity of the third region is S3, wherein 1.1%≤w1≤3.4%, 26.3%≤S1≤35.5%, 23.7%≤S2<26.3%, and 15.8%≤S3<23.7%.

18. The secondary battery according to claim 6, wherein the negative electrode active material comprises the carbon material and the silicon-containing substance; and based on a mass of the negative electrode material layer, a mass percentage of silicon element in the negative electrode material layer is w1, a porosity of the first region is S1, a porosity of the second region is S2, and a porosity of the third region is S3, wherein 3.3%≤w1≤10.2%, 31.6%≤S1≤42.6%, 28.4%≤S2<31.6%, and 18.9%≤S3<28.4%.

19. The secondary battery according to claim 5, wherein a porosity of the first region is S1, a porosity of the second region is S2, and a porosity of the third region is S3, wherein 1.01≤S1/S2≤1.5, and 1.01≤S2/S3≤1.5.

20. The secondary battery according to claim 19, wherein the negative electrode active material comprises a carbon material and a silicon-containing substance; and based on a mass of the negative electrode material layer, a mass percentage of silicon element in the negative electrode material layer is w1, wherein 1.1%≤w1≤3.4%, 26.3%≤S1≤35.5%, 23.7%≤S2<26.3%, and 15.8%≤S3<23.7%.
